(19) United States
(12) Patent Application Publication
(10) Pub. No.: US 2019/0354075 A1
(43) Pub. Date: Nov. 21, 2019

(54) SYSTEMS AND METHODS FOR FORMING A BUILDING INFORMATION MODEL

(71) Applicant: Johnson Controls Technology Company, Auburn Hills, MI (US)

(72) Inventors: Kathryn E. Christiansen, Liberty Township, OH (US); Jonathan M. Strayer, York, PA (US); Larry L. Loreman, Dover, PA (US); James B. Pittenger, Red Lion, PA (US); Michael W. Demmick, Hanover, PA (US)

(21) Appl. No.: 16/415,970

(22) Filed: May 17, 2019

Related U.S. Application Data
(60) Provisional application No. 62/673,552, filed on May 18, 2018.

(51) Int. Cl. G05B 17/02; G05B 15/02; G05B 19/418; G06F 17/50

(52) U.S. Cl. CPC G05B 17/02; G05B 15/02; G05B 2219/2642; G06F 17/5004; G05B 19/41885

(57) ABSTRACT

A method for forming a building information model (BIM) includes: receiving, by a BIM formation system, an input from a user, the input having a building model, an indication of a target component, and a parameter of the target component; selecting, by the BIM formation system, a component model associated with the target component; inputting, by the BIM formation system, the parameter into the component model to form a representative component model associated with the target component; and integrating, by the BIM formation system, the representative component model with the building model to form a component building model. The component model includes at least one of a 3D model of the target component or a 2D image of the target component.

### CROSS-REFERENCE TO RELATED PATENT APPLICATION

This application claims priority to U.S. Provisional Patent Application No. 62/673,552 filed on May 18, 2018, the entire disclosure of which is incorporated by reference herein.

### BACKGROUND

The present disclosure relates generally to a building information model (BIM) and more particularly to forming a BIM by integrating component files for components in the building with building information.

Forming a BIM is an important step in building design and construction and is typically performed by architects, engineers, and contractors. In general, a BIM may be formed using general models for buildings and objects of the buildings. However, such a BIM lacks a level of detail necessary to efficiently control operation of the building and is undesirable because it does not provide a level of detail to a user which is necessary to efficiently manage the building (e.g., financially, etc.). Once a BIM is formed, an engineer may implement BIM processes to run the building. For example, the engineer may activate an HVAC system and visualize the important of the HVAC system on the building (e.g., to determine if the desired cooling was obtained, etc.).

In some localities (e.g., regions, states, countries, etc.), a building cannot be constructed without an accurate BIM. As a result, completion of the construction of the building is dependent on obtaining enough information to form an accurate BIM. The BIM must include BIM models for all components in the building. Generating these BIM models is time consuming and delays construction and/or leads to lack of interest in the associated components. Accordingly, an opportunity exists to increase the value of components by being able to quickly provide accurate BIM models for these components.

### SUMMARY

One implementation of the present disclosure relates to a method for forming a BIM including: receiving, by a BIM formation system, an input from a user, the input having a building model, an indication of a target component, and a parameter of the target component; selecting, by the BIM formation system, a component model associated with the target component; inputting, by the BIM formation system, the parameter into the component model to form a representative component model associated with the target component; and integrating, by the BIM formation system, the representative component model with the building model to form a component building model. The component model includes at least one of a 3D model of the target component or a 2D image of the target component.

In some implementations, the parameter includes a dimension of the target component and inputting the parameter into the component model includes inputting the dimension into at least one parametric equation associated with the component model.

In some implementations, the method further includes selecting, by the BIM formation system, a first component file; selecting, by the BIM formation system, a second component file; assembling, by the BIM formation system, the first component file and the second component file into a part model; and assembling, by the BIM formation system, the component model from the part model. The first component file, the second component file, the part model, and the component model may be each defined by at least one parametric equation.

In some implementations, the representative component model includes a first connection point, the building model includes a second connection point, and integrating the representative component model with the building model includes connecting the first connection point and the second connection point.

In some implementations, the method further includes receiving, by the BIM formation system, building information associated with the building model and integrating the component building model and the building information to form a BIM.

Another implementation of the present disclosure relates to a method for forming a representative component model using a BIM formation system, the representative component model associated with a target component, the method including: providing, by the BIM formation system, a first component model, the first component model having a dimension that is defined by a first parametric equation; receiving, by the BIM formation system, a selection of the first component model; receiving, by the BIM formation system, a first parameter associated with a first target component; inputting, by the BIM formation system, the first parameter into the first parametric equation; generating, by the BIM formation system, a first representative component model in response to the first parameter being input into the first parametric equation; receiving, by the BIM formation system, a building model; and integrating, by the BIM formation system, the first representative component model into the building model to form a first BIM.

In some implementations, the method further includes: receiving, by the BIM formation system, a second parameter associated with a second target component different from the first target component; inputting, by the BIM formation system, the second parameter into the first parametric equation; generating, by the BIM formation system, a second representative component model in response to the second parameter being input into the first parametric equation; and integrating, by the BIM formation system, the second representative component model into the building model to form a second BIM.

In some implementations, the method further includes: providing, by the BIM formation system, a second component model, the second component model having a dimension that is defined by a second parametric equation; receiving, by the BIM formation system, a selection of the second component model; receiving, by the BIM formation system, a second parameter associated with a second target component; inputting, by the BIM formation system, the second parameter into the second parametric equation; generating, by the BIM formation system, a second representative component model in response to the second parameter being input into the second parametric equation; and integrating, by the BIM formation system, the second representative component model into the building model to form the first BIM.

In some implementations, the method further includes: providing, by the BIM formation system, an initial application user interface having a configuration option associated with a second component model; and providing, by the BIM formation system, a configuration user interface in response to receiving a selection of the configuration option, the configuration user interface operable to generate the second component model. In some implementations, the method further includes receiving, by the BIM formation system, a second parameter associated with a second target component different from the first target component; and determining that the second component model is unavailable. The initial application user interface may be provided by the BIM formation system in response to determining that the second component model is unavailable. The second component model may be associated with the second target component. In some implementations, the method further includes providing, by the BIM formation system, a component file behavior user interface associated with the second component model in response to receiving a selection of a model button provided on the configuration user interface; and importing, by the BIM formation system, a component file associated with the second component model in response to receiving a selection of an import button provided on the component file behavior user interface. In some implementations, the method further includes providing, by the BIM formation system, a component file assembly user interface associated with the second component model in response to receiving a selection of a component file assembly button provided on the configuration user interface; providing, by the BIM formation system, a component file assembly tree associated with the second component model, the component file assembly tree including: a component file base assembly entry associated with a first component file; a first component file assembly entry associated with a second component file configured to be assembled with the first component file; and a second component file assembly entry associated with a third component file configured to be assembled with the first component file; and the method further including facilitating, by the BIM formation system, rearrangement of the first component file assembly entry and the second component file assembly entry within the component file assembly tree. In some implementations, the method further includes: that the component file assembly tree dictates an order in which the first component file, the second component file, and the third component file are assembled to form the second component model; that the first component file is assembled to the second component file, and then the first component file and the second component file are assembled to the third component file when the second component file is located between the first component file and the third component file; and that the first component file is assembled to the third component file, and then the first component file and the third component file are assembled to the second component file when the third component file is located between the first component file and the second component file. In some implementations, the method further includes providing, by the BIM formation system, a parent component name and a child component name on the component file assembly user interface in response to receiving a selection of the first component file assembly entry or the second component file assembly entry, where the parent component name is associated with the component file base assembly entry and where the child component name is associated with the first component file assembly entry or the second component file assembly entry. In some implementations, the method further includes providing, by the BIM formation system, a parent constraint name and a child constraint name on the component file assembly user interface in response to receiving a selection of the first component file assembly entry or the second component file assembly entry, where the parent constraint name indicates a first constraint associated with the first component file, and between the first component file and the second component file or the third component file, and where the child constraint name indicates a second constraint associated with the second component file or the third component file, and between the first component file and the second component file or the third component file.

Yet another implementation of the present disclosure relates to a method for generating a component model using a BIM formation system, the method including: providing, by the BIM formation system, an initial application user interface having a configuration option associated with a component model; providing, by the BIM formation system, a configuration user interface in response to receiving a selection of the configuration option, the configuration user interface operable to generate the component model and having a model button associated with the component model; providing, by the BIM formation system, a component file behavior user interface associated with the component model in response to receiving a selection of the model button, the component file behavior user interface having an import button; importing, by the BIM formation system, a first component file associated with the component model in response to receiving a selection of the import button; and generating, by the BIM formation system, the component model using the first component file. The component model includes at least one parametric equation.

In some implementations, the method further includes: providing, by the BIM formation system, a component file assembly user interface associated with the component model in response to receiving a selection of a component file assembly button provided on the configuration user interface; providing, by the BIM formation system, a component file assembly tree associated with the component model, the component file assembly tree including: a component file base assembly entry; a first component file assembly entry; and a second component file assembly entry; and the method further includes facilitating, by the BIM formation system, rearrangement of the first component file assembly entry and the second component file assembly entry within the component file assembly tree; where one of the component file base assembly entry, the first component file assembly entry, or the second component file assembly entry corresponds to the first component file; and where the others of the component file base assembly entry, the first component file assembly entry, or the second component file assembly entry correspond to a second component file and a third component file. In some implementations, the component file assembly tree dictates an order in which the first component file, the second component file, and the third component file are assembled to form the component model, the first component file is assembled to the second component file, and then the first component file and the second component file are assembled to the third component file when the second component file is located between the first component file and the third component file, and the first component file is assembled to the third component file, and then the first component file and the third component file are assembled to the second component file when the third component file is located between the first component file and the second component file. In some implementations, the method further includes providing, by the BIM formation system, a parent component name and a child component name on the component file assembly user interface in response to receiving a selection of the first component file assembly entry or the second component file assembly entry; where the parent component name is associated with the component file base assembly entry and where the child component name is associated with the first component file assembly entry or the second component file assembly entry.

### BRIEF DESCRIPTION OF THE DRAWINGS

FIG. 1 is a drawing of a building equipped with a building management system (BMS), according to an exemplary embodiment.

FIG. 2 is a block diagram of a waterside system which may be used to provide heating and/or cooling to the building of FIG. 1, according to an exemplary embodiment.

FIG. 3 is a block diagram of an airside system which may be used to provide heating and/or cooling to the building of FIG. 1, according to an exemplary embodiment.

FIG. 4 is a block diagram of a BMS which may be used to monitor and control building equipment in the building of FIG. 1, according to an exemplary embodiment.

FIG. 5 is a block diagram of a building information model formation system, according to an exemplary embodiment.

FIG. 6 is a block diagram of a process for forming a building information model, according to an exemplary embodiment.

FIG. 7 is a block diagram of a component file, according to an exemplary embodiment.

FIG. 8 is a block diagram of a component file creation system, according to an exemplary embodiment.

FIG. 9 is a block diagram of a process for forming a building information model, according to an exemplary embodiment.

FIG. 10 is an initial application user interface for a BIM formation system, according to an exemplary embodiment.

FIG. 11 is a user access level user interface for a BIM formation system, according to an exemplary embodiment.

FIG. 12 is a configuration user interface for a BIM formation system, according to an exemplary embodiment.

FIG. 13 is a mapping user interface for a BIM formation system, according to an exemplary embodiment.

FIG. 14 is a calculation user interface for a BIM formation system, according to an exemplary embodiment.

FIG. 15 is a metadata user interface for a BIM formation system, according to an exemplary embodiment.

FIG. 16 is a component file behavior user interface for a BIM formation system, according to an exemplary embodiment.

FIG. 17 is a component file assembly user interface for a BIM formation system, according to an exemplary embodiment.

FIG. 18 is a constraints user interface for a BIM formation system, according to an exemplary embodiment.

FIG. 19 is a part definitions user interface for a BIM formation system, according to an exemplary embodiment.

FIG. 20 is an engineering order manual (EOM) tabulation user interface for a BIM formation system, according to an exemplary embodiment.

FIG. 21 is a column user interface for a BIM formation system, according to an exemplary embodiment.

FIG. 22 is a connection user interface for a BIM formation system, according to an exemplary embodiment.

FIG. 23 is an exclusion user interface for a BIM formation system, according to an exemplary embodiment.

FIG. 24 is a testing user interface for a BIM formation system, according to an exemplary embodiment.

FIG. 25 is an analyzer user interface for a BIM formation system, according to an exemplary embodiment.

FIG. 26 is a block diagram of a modeling process using a BIM formation system, according to an exemplary embodiment.

### DETAILED DESCRIPTION

### Overview

Referring generally to the FIGURES, systems and methods for forming a building information model (BIM) for a building are shown, according to an exemplary embodiment. A BIM is a representation of a building in 3-dimensional (3D) space. The BIM includes models of components in the building. Beyond illustrating the building and components therein in 3D, the BIM also illustrates how the components interact with the building. For example, the BIM illustrates the physical location of the components within the building and how the connections (e.g., electrical connections, fluid connections, etc.) on the components interact with connections (e.g., electrical connections, fluid connections, etc.) in the building. Accordingly, it is important that the models of the components be accurate. Furthermore, a BIM cannot be completed without the models for the components. Some localities prohibit construction of a building without a BIM including models for at least some of the components included in the building. Thus, completion of the models of the components is an important step in forming a BIM.

Using typical methods, creating the model for a component is a time consuming process because the model must be formed by using much of the same information used to construct the component itself. First, a product line for the component is determined. Then, engineering order manuals (EOMs) for that product line are collected. The EOMs include part numbers and listings for various configurations of the component, where each configuration is associated with a product identification number (PIN). Next, all the drawings (e.g., engineering drawings, etc.) and electronic documentation for that component are collected and reviewed to ascertain all parts necessary to define the component in a model. For example, the wiring diagrams for a component are usually analyzed to determine the electrical hookup for a model of a component. Finally, all relevant information is utilized to dimension and construct the model for the component.

While components typically have computer aided design (CAD) models associated therewith for the purposes of production and manufacturer of the component, converting these models for use in the BIM is undesirable because CAD models include more detail than the BIM requires, more detail than a user would typically like, and more detail than the producer of the component is typically willing to disclose. New models, separate from the existing CAD models, are typically created because it is usually more time consuming to scrub the CAD models of this excess detail than it is to create new models separate from the CAD models.

Creating new models for each component may require creation of several subassemblies where are later assembled together. In order to obtain accurate results, the model can only be created by examining the drawings and CAD models which already exist for the component. When completed, the model for a component includes connection points (e.g., points at which the component connects to surrounding components in the building, points at which the component connects to the building, etc.). The model for the component may then be sent to users of the component for integration into the BIMs of those users.

The systems and methods described herein may be used to create models of components for integration into a BIM without remaking the model from scratch and without extensively editing an existing CAD model. In this way, the systems and methods described herein may facilitate faster creation of a model of a component, thereby allowing a BIM to be completed faster and increasing the desirability of the component. Furthermore, the models for the component may be easily updated due to the centralized location and organization of the models.

The BIM for a building includes BIM models for components within the building. Construction of a new building is typically prohibited without a complete BIM for the building, including the BIM models for the components planned to be located within the building. When a component is created by a manufacturer, creating the BIM model for that component is time consuming. The BIM model must include information about the component's configuration and dimensions, as well as other information about the product which may be stored in an electronic database, electronic records system, two-dimensional engineering drawings, and other similar sources. Additional features and advantages of the present disclosure are described in greater detail below.

### Building Management System and HVAC System

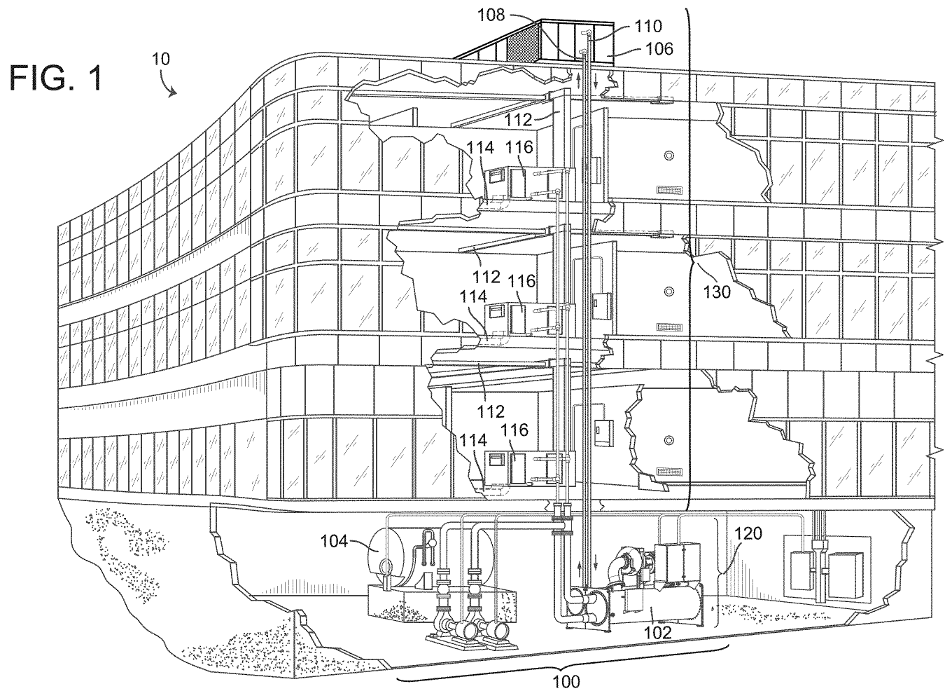

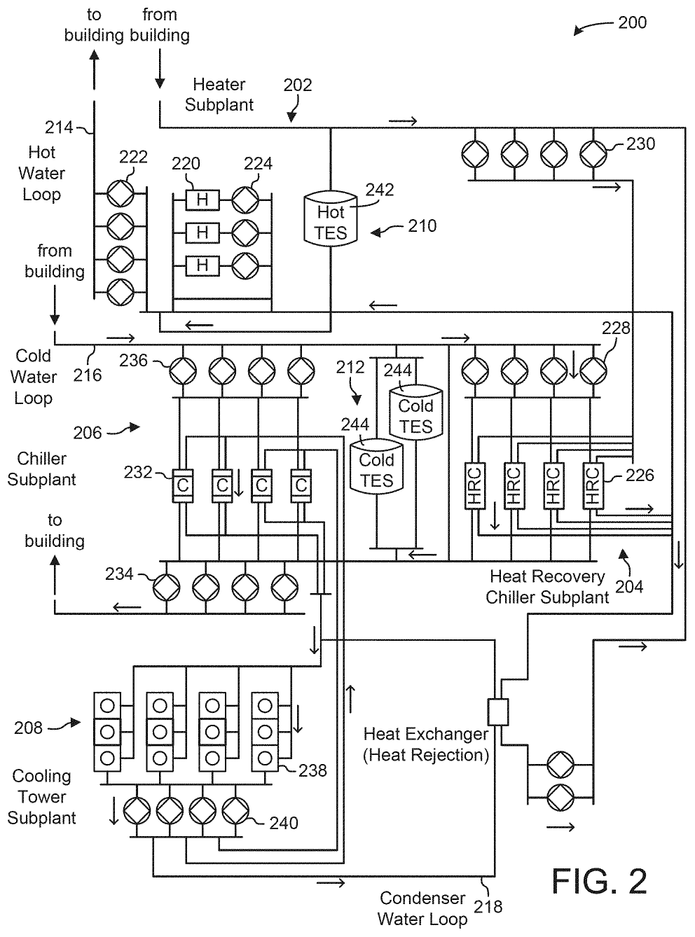

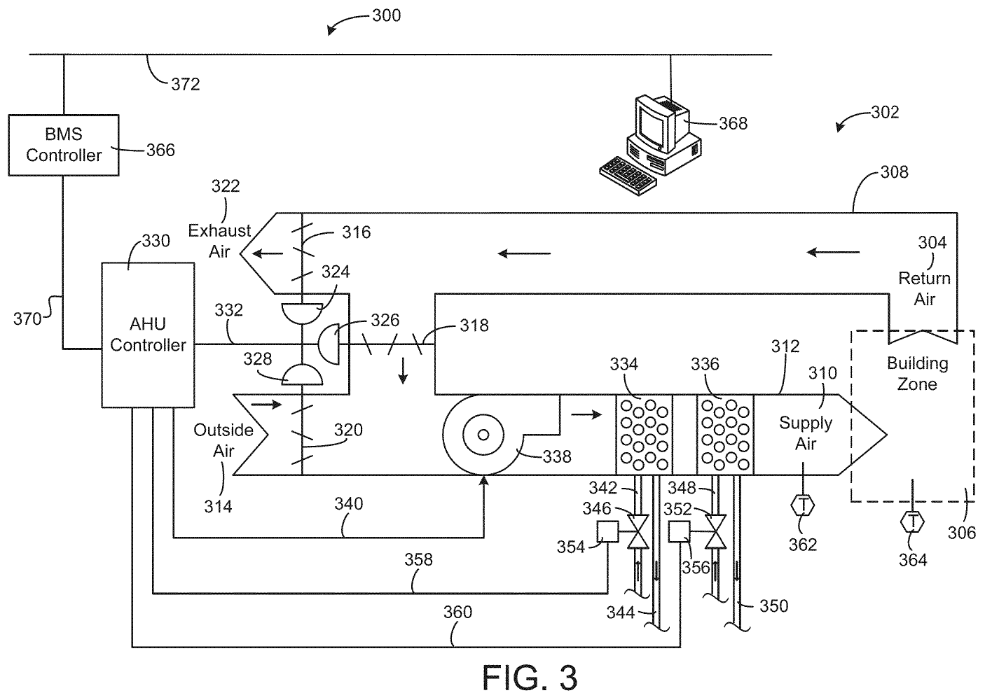

Referring now to FIGS. 1-4, an exemplary building management system (BMS) and HVAC system in which the systems and methods of the present invention may be implemented are shown, according to an exemplary embodiment. Referring particularly to FIG. 1, a perspective view of a building 10 is shown. Building 10 is served by a BMS which includes a HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2 and 3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

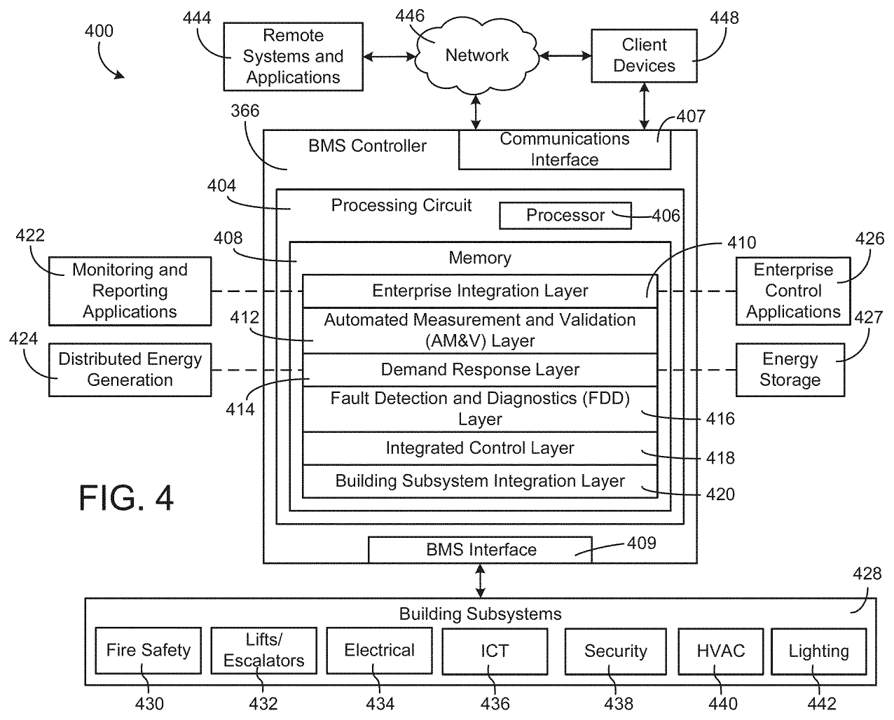

Referring now to FIG. 4, a block diagram of a building management system (BMS) 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, .xml files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### System for Forming a Building Information Model

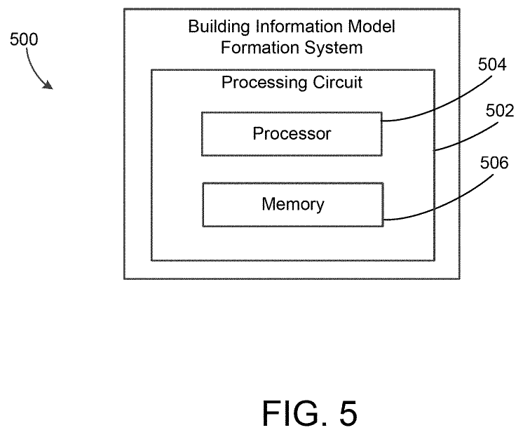

Referring now to FIG. 5 a building information model (BIM) formation system 500 for forming a BIM is shown, according to an exemplary embodiment. BIM formation system 500 automates assembly of a BIM (e.g., a 3D BIM object, etc.) using a component building model and building information. In this way, BIM formation system 500 enables a BIM to be formed by a person with significantly less technical training than a person forming a BIM using typical methods (e.g., manually converting a CAD file into a BIM model, etc.).

BIM formation system 500 includes a processing circuit 502. Processing circuit 502 has a processor 504 and a memory 506. Processing circuit 502 may be communicably connected to an interface (e.g., BMS interface 409, communications interface 407, etc.) such that processing circuit 502 and the various components thereof can send and receive data via the interface. Processor 504 can be implemented as a general purpose processor, an application specific integrated circuit (ASIC), one or more field programmable gate arrays (FPGAs), a group of processing components, or other suitable electronic processing components.

Memory 506 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 506 may be or may include volatile memory or non-volatile memory. Memory 506 may include database components, object code components, script components, or any other type of information structure for supporting the various activities and information structures described in the present application. According to an exemplary embodiment, memory 506 is communicably connected to processor 504 via processing circuit 502 and includes computer code for executing (e.g., by processing circuit 502 and/or processor 504) one or more processes described herein.

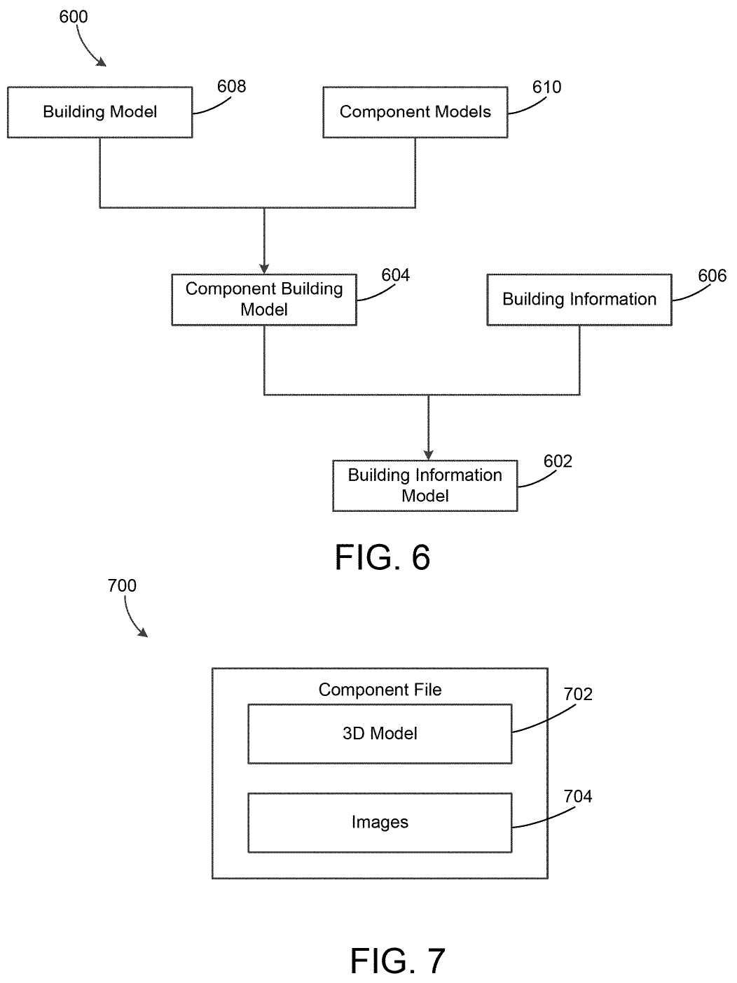

Referring to FIG. 6, a process 600 for forming a BIM 602 is shown. BIM 602 is formed by integrating a component building model 604 with building information 606. As will be described in more detail herein, BIM 602 is capable of being dynamically updated through changes to component building model 604 and/or building information 606.

Component building model 604 is a model (e.g., 3D model, computer-aided design (CAD) model, etc.) of a building, such as the building 10 shown and described in FIGS. 1-4, including the various components contained within the building, such as various components of the BMS (e.g., various components of the HVAC system 100, etc.). Component building model 604 is formed by integrating a building model 608 with at least one component model 610 associated with building model 608. Component model 610 is a model of a component (e.g., a piece of building equipment, components of the BMS, clearance zones, etc.).

Building model 608 is a 3D representation of the building without any components. Building model 608 may include models of walls, windows, floors, piping, ductwork, electrical components, and other objects which are part of the structure of the building, but which are not components of the building. Unlike component building model 604, which is updated by making changes to component models 610, building model 608 is not intended to be updated frequently. Once building model 608 has been constructed, changes to building model 608 are infrequent because changes to the building are infrequent (e.g., changes only occur when the building is renovated, etc.).

On its own, component building model 604 provides significant utility to a user. For example, component building model 604 facilitates visualization of the building based on the specific configuration of the building. Component building model 604 is not a generic model, the relevance of which has to be extrapolated by a user to the user's building. Instead, component building model 604 is customized to be an accurate representation of the building with the components included in the building being accurately shown and located within the building.

Building information 606 may include metadata associated with component building model 604. For example, building information 606 may include wall insulation, window insulation, fluid flows within the building (e.g., due to the components in the building, etc.), air flows (e.g., due to the components in the building, etc.), electrical loads (e.g., due to the components in the building, etc.) structural loads (e.g., due to the components in the building, etc.), materials of the building and/or components in the building, pricing of the building and/or components in the building, manufacturer of the building and/or components in the building, internet or intranet links to additional information regarding the building and/or components in the building, and other similar data. Live data can be added to BIM 602 as described in, for example, U.S. patent application Ser. No. 15/872,572 and U.S. patent application Ser. No. 15/872,653, each of which is incorporated by reference herein in its entirety.

Building information 606 may include, for example, real-time or live data from a BMS (e.g., BMS 400, etc.). The real-time or live data may include, for example, readings from sensors, equipment states, current operating capacities, and other similar information relating to a BMS. In this way, building information 606 facilitates monitor and control of the BMS by a user based upon real-time or live data.

The integration of building information 606 with component building model 604 causes building information 606 to be associated with component models 610 in component building model 604. For example, building information 606 may include an electrical load of a chiller in a building and the integration of component building model 604 and building information 606 associates this electrical load with the model of the chiller in component models 610.

Referring to FIG. 7, a component file 700 is shown, according to an exemplary embodiment. At least one component file 700 is modified to be included in component models 610. Each component file 700 is associated with a component in the building. Component models 610 include the component files 700 of each of the components in the building. For example, if the building includes a chiller and an air damper, component models 610 include a component file 700 for the chiller and a component file 700 for the air damper.

Each component file 700 includes a 3D model 702 of the component and images 704 of the component. 3D models 702 are parametric (e.g., are paradigm models, etc.) so as to be easily scaled up and down (e.g., for components of various sizes, etc.). 3D model 702 may be a 3D Revit® file. 3D model 702 may comply with architectural, mechanical, electrical, and plumbing standards. In various embodiments, 3D model 702 includes various connectors, fluid flows, scheduling data, and other similar information relating to the component. 3D model 702 may be in various formats such as, for example, .rfa, .adsk, .iges, .dwg, and .sat.

Images 704 are still images derived from 3D model 702. For example, images 704 may be an isometric vie of 3D model 702, a front view of 3D model 702, a rear view of 3D model 702, a top view of 3D model 702, a bottom view of 3D model 702, a left side view of 3D model 702, and a right side view of 3D model 702. Images 704 may be in various formats such as, for example, .pdf, .png, .jpg, .gif, and .tif.

Each component file 700 is unique to its corresponding component. For example, if the chiller in the building is a York® YZ Centrifugal Chiller then component file 700 for the chiller includes a 3D model of a York® YZ Centrifugal Chiller and images 704 of the York® YZ Centrifugal Chiller.

The way in which the components interact with the building is mirrored in the way in which component models 610 interact with building model 608. For example, if the chiller has a specified electrical input and the building has a specified electrical output connected to the electrical input, 3D model 702 for component file 700 of the chiller includes the specified electrical input and building model 608 includes the specified electrical output connected to the electrical input. Furthermore, 3D model 702 and images 704 for component file 700 are scaled relative to building model 608. As a result, when component models 610 are integrated with building model 608, component models 610 are each located and configured within building model 608 are the corresponding components are in the building. In this way, component building model 604 may be an accurate (e.g., reliable, consistent, etc.) 3D representation of the physical components and configuration of the building.

By integrating building information 606 with component building model 604, BIM 602 is an accurate representation of the building which can be updated as building information 606, component models 610, and/or building model 608 changes. As component models 610 are added, removed, or replaced, BIM 602 correspondingly changes. For example, when a model of an air damper is changed, an old component model 610 is deleted and a new component model 610 is inserted. This change may cause a change in an air flow associated with the air damper, and this change may be observed in building information 606.

The efficacy and desirability of a BIM is directly related to the accuracy of the models of the components included therein and the time it takes to acquire these models. Typically, creation of these models is a time consuming task and may require manual re-entry of information from records for the component. As a result, typical components and the BIM are undesirable.

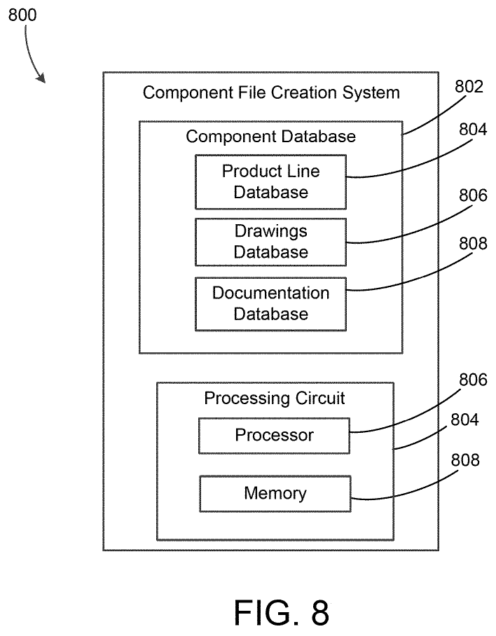

Referring now to FIG. 8, a component file creation system 800 for creating component file 700 is shown, according to an exemplary embodiment. Component file creation system 800 replaces typical methods of creating a model of a component, such as by manually examining engineering drawings and documentation for the component and redrawing the model. As a result, component file creation system 800 is capable of producing component file 700 faster and more accurately than typical methods.

Component file creation system 800 includes a component database 802 and a processing circuit 810. Component database 802 contains all the information (e.g., drawings, dimensions, etc.) relating to all components. Component database 802 may be updated to include information relating to new components and to update information of all other components. Component file creation system 800 is capable of automatically sorting through the information for all of the components to obtain the information necessary to create component file 700 for a target component.

Component database 802 includes a product line database 804. Product line database 804 includes tables and data sets. The tables and data sets included in product line database 804 contain lists of all subcomponents (e.g., subassemblies, parts, etc.) which are required to assemble the component (e.g., in a bill of materials, etc.). The tables and data sets included in product line database 804 define order of assembly of various subcomponents for each component. The tables and data sets included in product line database 804 define connection points for all components (e.g., the connection points on one subcomponent which are attached to the connection points of another subcomponent, etc.). The tables and data sets included in product line database 804 also define optional configurations (e.g., specialized configurations, etc.) and variations for each component.

The tables and data sets included in product line database 804 also list templates corresponding for each of a number of generic components, where the component is associated with (e.g., a specific configuration of, etc.) one of the generic components. Templates are parametric versions of components which can be used to create a component by simply inserting dimensions and configurations received from component database 802 into parametric equations (e.g., the length of a component is equal to 0.5x where x is the input to the parametric equation, etc.), rather than by assembling a plurality of subcomponents.

The tables and data sets included in product line database 804 also includes mapping between parameters included in the request from the user of BIM 602 and the various variables in the various parametric equations of the various models, so that the parametric equations can be solved and the model created. The tables and data sets included in product line database 804 may also include criteria for using various configurations of the components in BIM 602. For example, if BIM 602 only has electrical connectors of a certain voltage, the component may need to be configured to have an electrical connector suitable for that voltage. The tables and data sets included in product line database 804 may also associate part numbers to dimensional values. For example, one table may include part numbers for each component and another value may include dimensional values for each part number.

The tables and data sets included in product line database 804 may also track modifications and/or updates of certain components or subcomponents. In this way, the components can be organized more efficiently, such as based on version. The tables and data sets included in product line database 804 may also include parent/child relationships of various components and subcomponents based on, for example, part number. Similarly, the tables and data sets included in product line database 804 may correspond configurations of the component to specific part numbers. In this way, when an input includes a part number, component file creation system 800 can easily determine a component and its configuration. The tables and data sets included in product line database 804 can also define product identification numbers, EOM numbers, part mappings, drawing numbers, revision information, part definitions, and Logia options for all components.

Drawings database 806 may include drawings associated with each of the components in component database 802. Similarly, documentation database 808 may include documentation, such as engineering schematics and other files, relating to each of the components in component database 802.

Product line database 804, drawings database 806, and documentation database 808 may be assembled by, for example, a manufacturer or operator of component file creation system 800. Product line database 804, drawings database 806, and documentation database 808 maybe organized using common data naming conventions. Component file creation system 800 is configured to create models based on criteria (e.g., prescribed dimensional tolerances, etc.) defined by the manufacturer or operator of component file creation system 800. Information may be input, either by the user of BIM 602 or by the manufacturer or operator of component file creation system 800, into component database 802 using a graphical user interface (GUI) (e.g., guided GUI, etc.).

Processing circuit 810 has a processor 812 and a memory 814. Processing circuit 810 may be communicably connected to an interface (e.g., BMS interface 409, communications interface 407, etc.) such that processing circuit 810 and the various components thereof can send and receive data via the interface. Processor 812 can be implemented as a general purpose processor, an application specific integrated circuit (ASIC), one or more field programmable gate arrays (FPGAs), a group of processing components, or other suitable electronic processing components.

Memory 814 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 814 may be or include volatile memory or non-volatile memory. Memory 814 may include database components, object code components, script components, or any other type of information structure for supporting the various activities and information structures described in the present application. According to an exemplary embodiment, memory 814 is communicably connected to processor 812 via processing circuit 810 and includes computer code for executing (e.g., by processing circuit 810 and/or processor 812) one or more processes described herein.

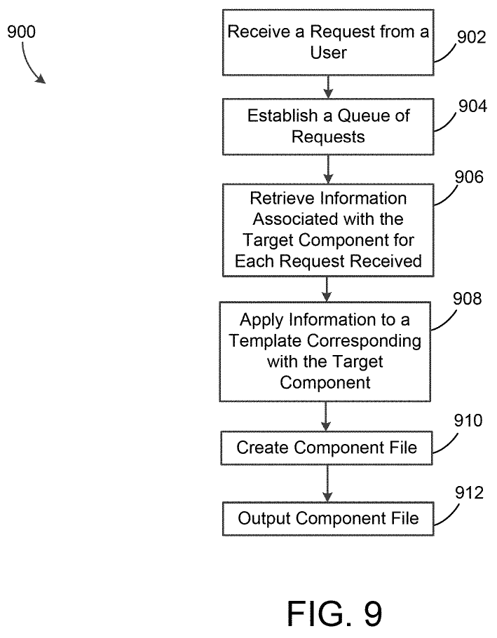

Referring now to FIG. 9, a component file creation process 900 is shown, according to an exemplary embodiment. Component file creation process 900 is performed by component file creation system 800. Component file creation process 900 is configured to be initiated by a user of BIM formation system 500. Component file creation process 900 is configured to receive, in block 902, a request from a user of BIM formation system 500. This request defines a product data set associated with a target component. Specifically, the user requests a component file associated with the target component. For example, the user may request the component file for an air handling unit. The request received by component file creation system 800 includes a file (e.g., .xml file, etc.) including information associated with the target component. The file may be formatted in Logia format or any other standardized format. Component file creation process 900 also supports administrative access to system queues and model requests by an administrator (e.g., other than the user of BIM formation system 500, etc.).

In some instances, component file creation system 800 is centralized and configured to receive requests from users of multiple BIM formation systems 500. For example, component file creation system 800 may field requests from an array of BIM formation systems 500 associated therewith. Component file creation process 900, in block 904, establishes a queue of requests from the users of BIM formation systems 500. Component file creation process 900 may organize the queue of requests based on, for example, order in which the requests were received.

For each of the request component file creation system 800 receives, component file creation system 800 retrieves, in block 906, information (e.g., drawings, measurements, configurations, etc.) associated with the target component included in the request. Component file creation system 800 matches input values (e.g., values from the .xml file, etc.) with product line component options or codes (e.g., Logia codes, etc.) stored in component database 802 and then retrieves the information associated therewith. Depending on how the information is stored in component database 802, component file creation system 800 may request information for various subcomponents of the target component (e.g., where the subcomponents can be assembled by component file creation system 800 into the target component, etc.).

Component file creation system 800 then applies, in block 908, the information to a template corresponding with the target component. Component database 802 may store a plurality of templates, each corresponding with a different component. For example, the template may be a component with dynamically adjustable dimensions such that component file creation system 800 can obtain the target dimensions from component database 802, obtain the template from component database 802, and apply the dimensions to the template.

Component file creation system 800 then creates, in block 910, component file 700 by using the retrieved information to construct 3D model 702 and subsequently obtain images 704. For example, applying the dimensions to the template may cause the model for the component, or for a subcomponent of the component, to be created.

After component file 700 has been assembled, component file creation system 800 then outputs, in block 912, component file 700 from component file creation system 800. Component file creation system 800 also outputs, in addition to component file 700, any error notifications or tracking information created along with component file 700.

After component file 700 of a component has been created (e.g., by a manufacturer of the component, by a designer of the component, instantiated, etc.), component file 700 may be made available (e.g., in a library, on a cloud server, etc.) for the BIM formation system 500 to download for use in forming component models 610. The BIM formation system 500 may then download component models 610 for integration with building model 608.

User Interfaces for Interacting with a BIM Formation System to Form a BIM

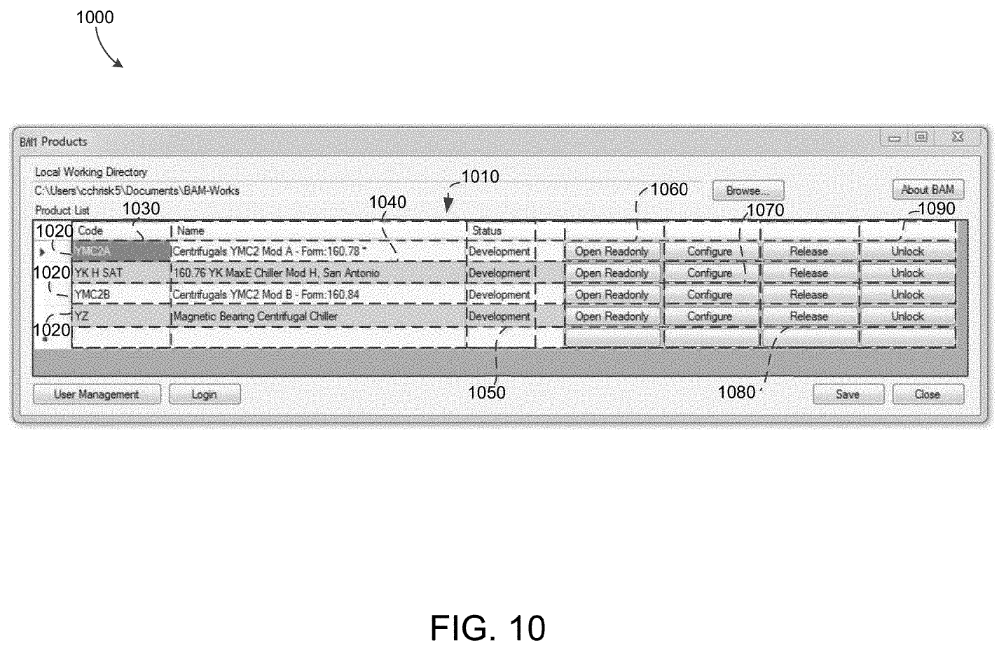

Referring now to FIG. 10, an initial application user interface 1000 is shown, according to an exemplary embodiment. Initial application user interface 1000 is provided to a user by BIM formation system 500 and implements component file creation process 900. Initial application user interface 1000 may be provided to a user prior to block 902 in component file creation process 900. Additionally, initial application user interface 1000 may be provided to a user in response to BIM formation system 500 determining that component model 610 for the target component is not yet released for use by BIM formation system 500.

Initial application user interface 1000 includes a product list 1010 with at least one component entry 1020. Each component entry 1020 corresponds with a component. Each component entry 1020 includes a code 1030, a name 1040, and a status 1050. Code 1030, name 1040, and status 1050 within a single component entry 1020 correspond to the component associated with component entry 1020. Code 1030 may be a short code (e.g., electronic database identifier, etc.) associated with the component. Name 1040 may be a name (e.g., product name, product family name, configuration model name, etc.) associated with the component. Status 1050 may be convey an indication as to whether the component file for an component entry 1020 is available for BIM formation system 500 to utilize. For example, status 1050 may recite “Development” indicating that the component file associated with a component entry 1020 is not available for BIM formation system 500 to utilize.

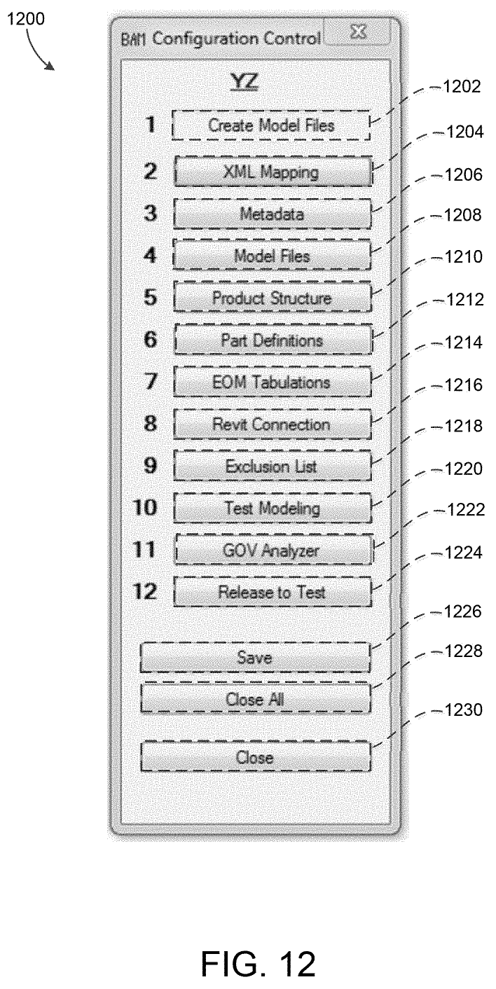

Each component entry 1020 also includes an open option 1060, a configuration option 1070, a release option 1080, and an unlock option 1090. Selection of open option 1060 may cause the component file associated with component entry 1020 to be opened in a read-only mode (e.g., such that configuration of the component file is prohibited, etc.). Selection of configuration option 1070 may cause the component file associated with component entry 1020 to be opened such that the component file may be configured in a configuration user interface, as described with reference to FIG. 12. Selection of release option 1080 may cause the component file associated with component entry 1020 to be made available for BIM formation system 500 to utilize. As a result of selecting release option 1080, status 1050 may change (e.g., from “Development” to “Ready,” etc.). Selection of unlock option 1090 may enable the user to provide access to component entry 1020 to other users (e.g., users with different access levels, etc.).

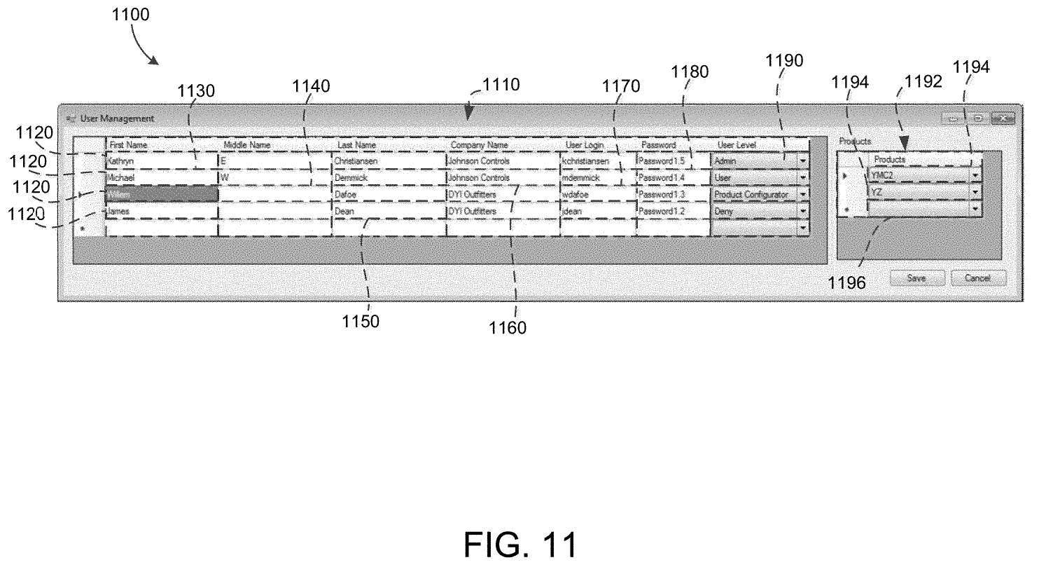

In various embodiments, BIM formation system 500 is configured to determine an access level of the user and alter operations according to the access level. In some embodiments, the access levels include: administrator; standard user; product configurator user; view only user; and denied user. In these embodiments, initial application user interface 1000 is differently presented to each access level. For administrators, component entries 1020 each include code 1030, name 1040, status 1050, open option 1060, configuration option 1070, release option 1080, and unlock option 1090. Additionally, initial application user interface 1000 may enable administrators to create new users and assign users an access level, as described with reference to FIG. 11, and may enable administrators to purge deleted items. For standard users, component entries 1020 each include code 1030, name 1040, status 1050, open option 1060, and configuration option 1070. For product configurator users, some component entries 1020, such as those the product configuration is assigned to, include code 1030, name 1040, status 1050, open option 1060, and configuration option 1070, but do not include release option 1080 and unlock option 1090, while other entries, such as those that the product configurator is not assigned to, include code 1030, name 1040, status 1050, and open option 1060, but do not include configuration option 1070, release option 1080, and unlock option 1090. For view only users, component entries 1020 each include code 1030, name 1040, status 1050, and open option 1060, but do not include configuration option 1070, release option 1080, and unlock option 1090. For view only users, component entries 1020 each include code 1030, name 1040, status 1050, and open option 1060, but do not include configuration option 1070, release option 1080, and unlock option 1090. For deny users, component entries 1020 each include code 1030, name 1040, and status 1050, but do not include open option 1060, configuration option 1070, release option 1080, and unlock option 1090.

Referring now to FIG. 11, a user access level user interface 1100 is shown, according to an exemplary embodiment. User access level user interface 1100 is provided to an administrator (e.g., as opposed to a standard/product configuration/view only/denied user, etc.) by BIM formation system 500.

User access level user interface 1100 includes a user list 1110 with at least one user entry 1120. Each user entry 1120 corresponds with a user. Each user entry 1120 may include a first name 1130, a middle name 1140, a last name 1150, a company name 1160, a user login 1170, a user password 1180, and a user access level 1190. Each first name 1130, middle name 1140, last name 1150, company name 1160, user login 1170, user password 1180, and user access level 1190 for each user entry 1120 may be edited by the administrator. User access level 1190 may provide a dropdown list from which the administrator can select the access level.

The user entries 1120 correspond to users who can access initial application user interface 1000. Therefore, using user access level 1190 within user access level user interface 1100 enables to administrator to access levels for each user who can access initial application user interface 1000. For example, the administrator can assign one user the standard user access level, another user the product configurator user access level, another user the view only user access level, and another user the denied user access level. Of course, two users may be assigned the same access level and there is no requirement that all access levels be present amongst the users.

When a user entry 1120 is selected that is assigned a product configurator user level, or when the administrator assigns a user entry 1120 the product configurator user access level, a product list 1192 is displayed separate from the user list 1110. The product list 1192 includes component selections 1194 which can be filled out by the administrator to assign the user to various components. The components which are assigned to a user with the product configurator user access level within the product list 1192 are the products which the user is assigned to an is therefore provided code 1030, name 1040, status 1050, open option 1060, and configuration option 1070, but not release option 1080 and unlock option 1090, within initial application user interface 1000.

Referring now to FIG. 12, a configuration user interface 1200 is shown, according to an exemplary embodiment. Configuration user interface 1200 is provided to a user by BIM formation system 500 in response to configuration option 1070 being selected. As is described in more detail herein, configuration user interface 1200 facilitates configuration of the component associated with configuration option 1070.

Configuration user interface 1200 includes a create model button 1202, according to an exemplary embodiment. In response to receiving a selection of create model button 1202, BIM formation system 500 creates a component model 610. Component model 610 may be created outside of BIM formation system 500 and for use with BIM formation system 500.

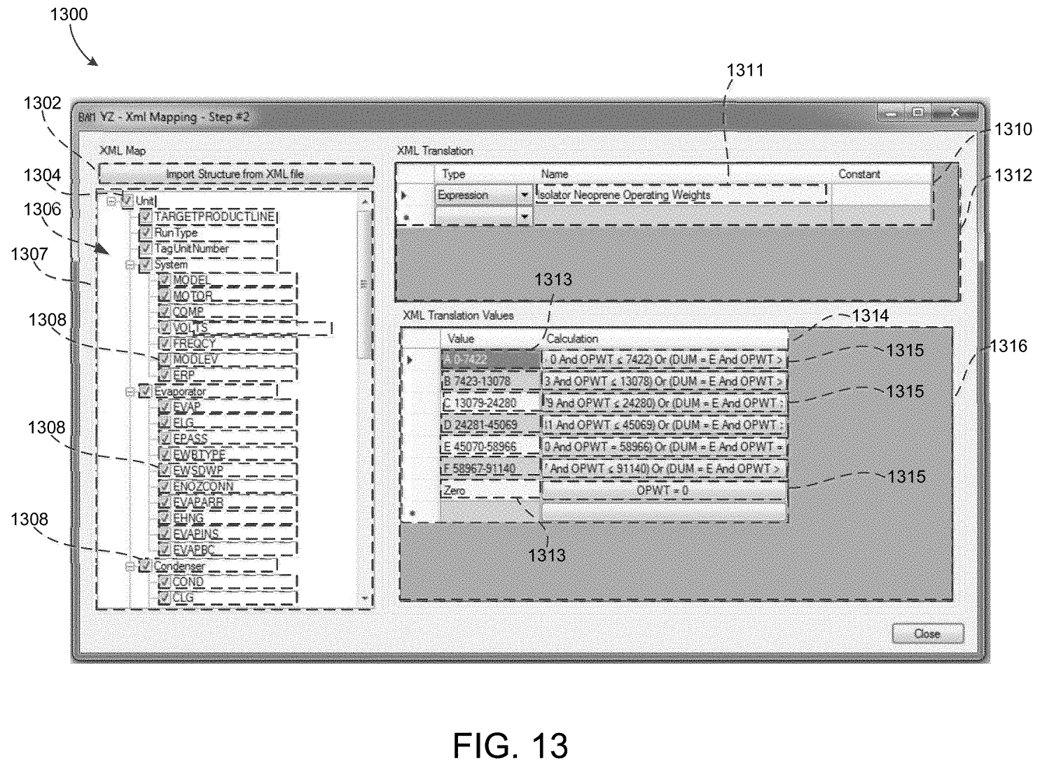

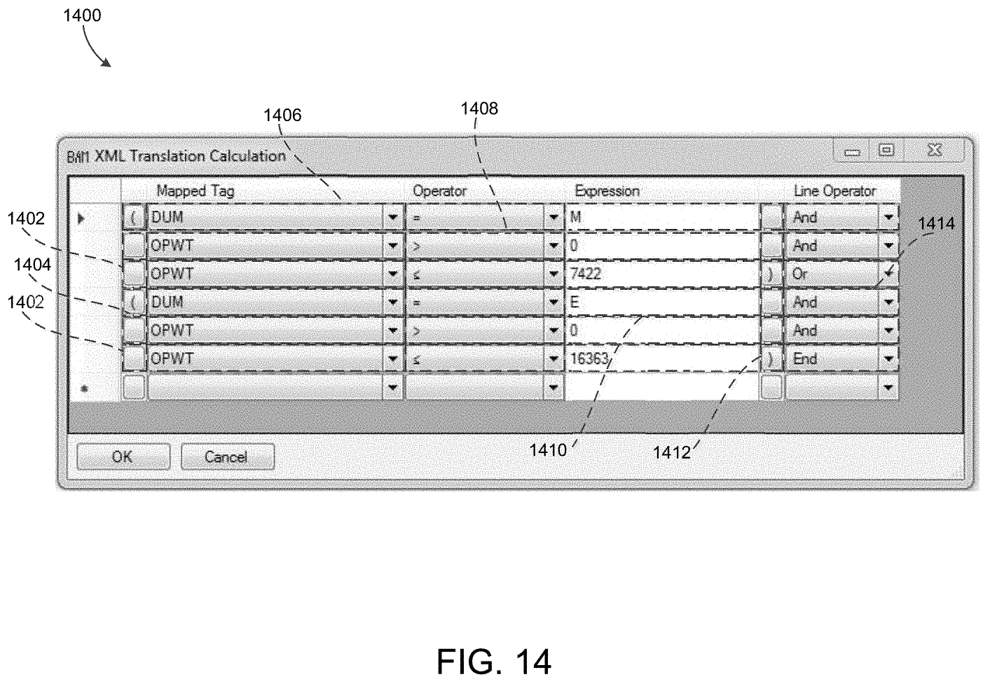

Configuration user interface 1200 also includes an .xml mapping button 1204, according to an exemplary embodiment. In response to receiving a selection of .xml mapping button 1204, BIM formation system 500 maps .xml nodes to codes (e.g., scripts, etc.) used throughout process 600. This mapping is described in more detail in FIGS. 13 and 14.

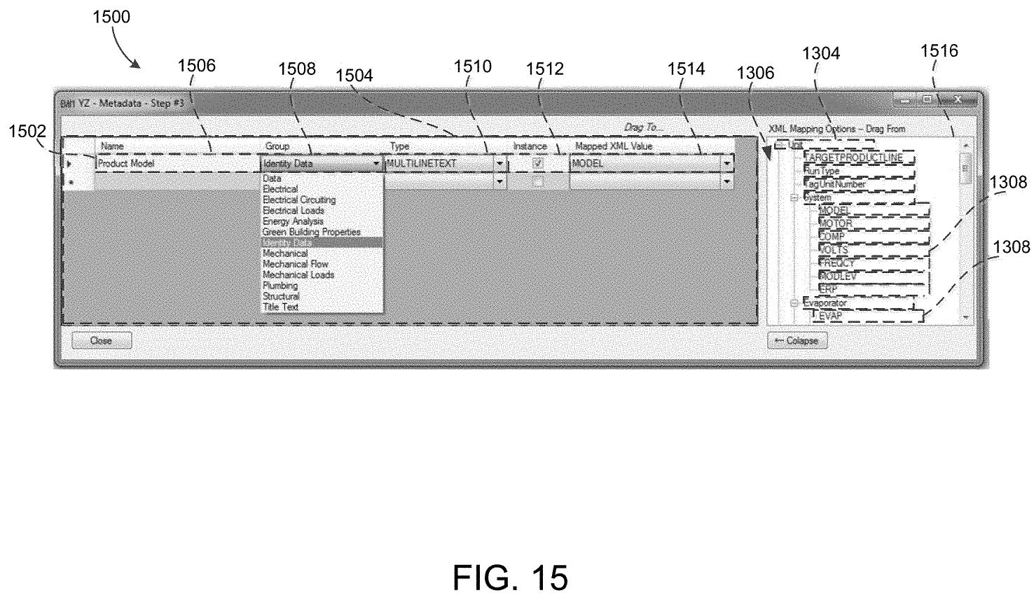

Configuration user interface 1200 also includes a metadata button 1206, according to an exemplary embodiment. In response to receiving a selection of metadata button 1206, BIM formation system 500 facilitates association of metadata (e.g., data specific to a customer's order, etc.) with .xml nodes. This process is described in more detail in FIG. 15.

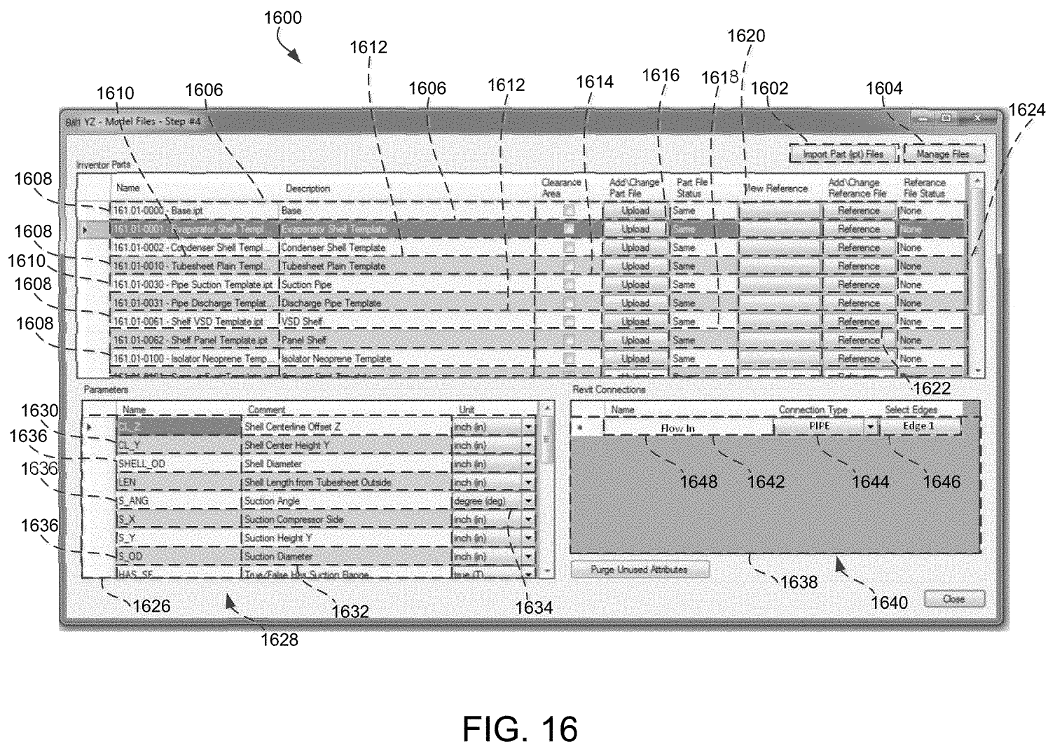

Configuration user interface 1200 also includes a component file behavior button 1208, according to an exemplary embodiment. In response to receiving a selection of component file behavior button 1208, BIM formation system 500 defines behavior of the component file. This process is described in more detail in FIG. 16.

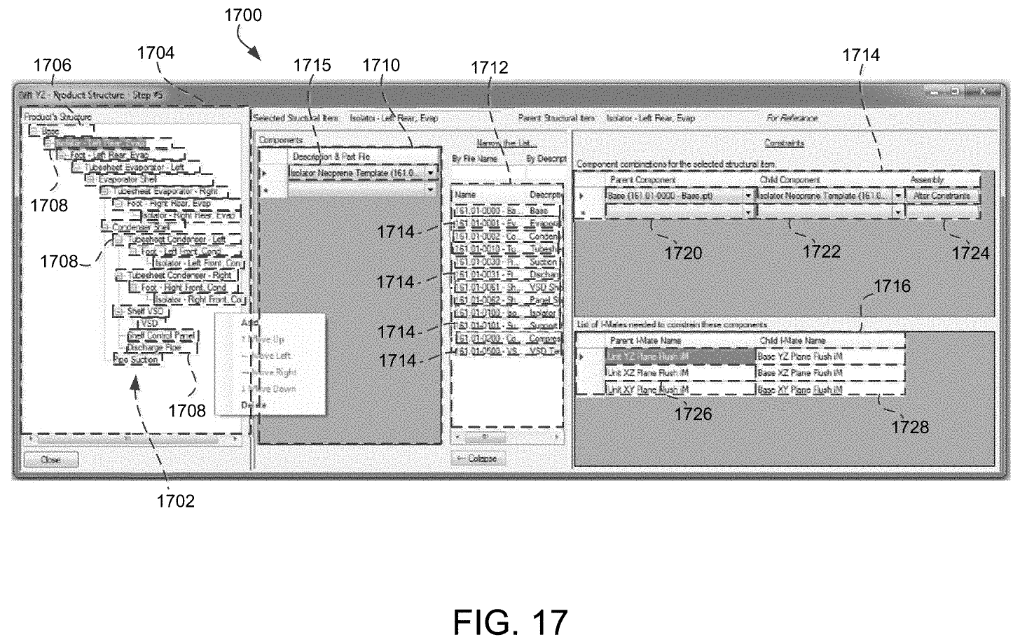

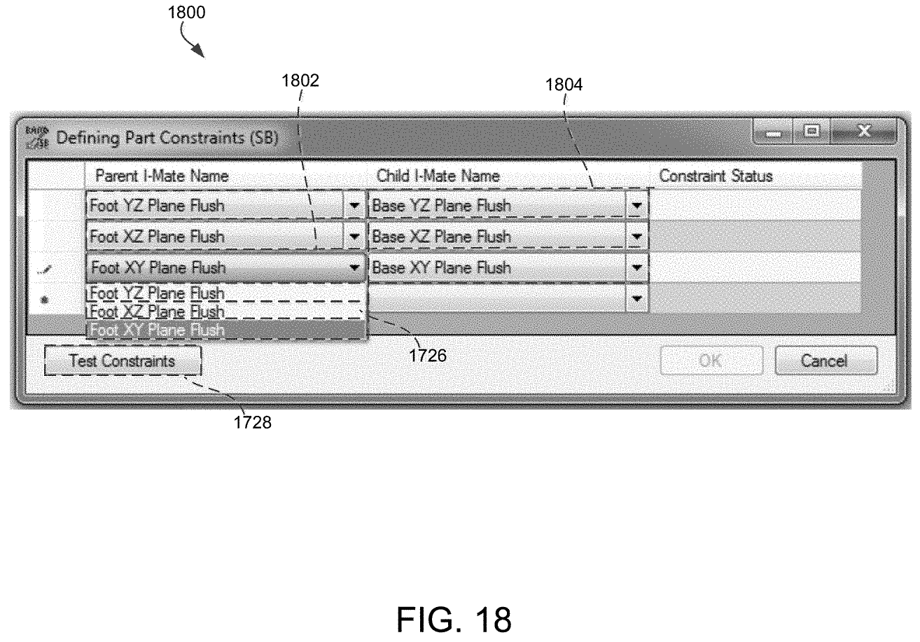

Configuration user interface 1200 also includes a component file assembly button 1210, according to an exemplary embodiment. In response to receiving a selection of component file assembly button 1210, BIM formation system 500 defines structure of the component including location of the component respective to other components. This process is described in more detail in FIGS. 17 and 18.

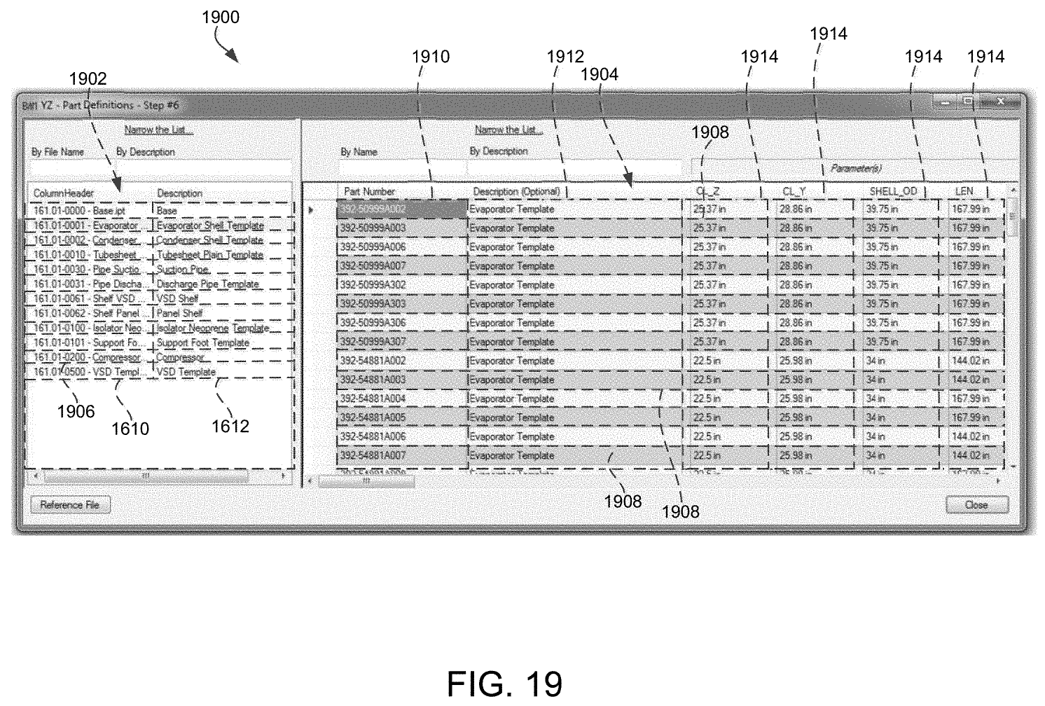

Configuration user interface 1200 also includes a part definitions button 1212, according to an exemplary embodiment. In response to receiving a selection of part definitions button 1212, BIM formation system 500 defines parameter values for generating a component model. This process is described in more detail in FIG. 19.

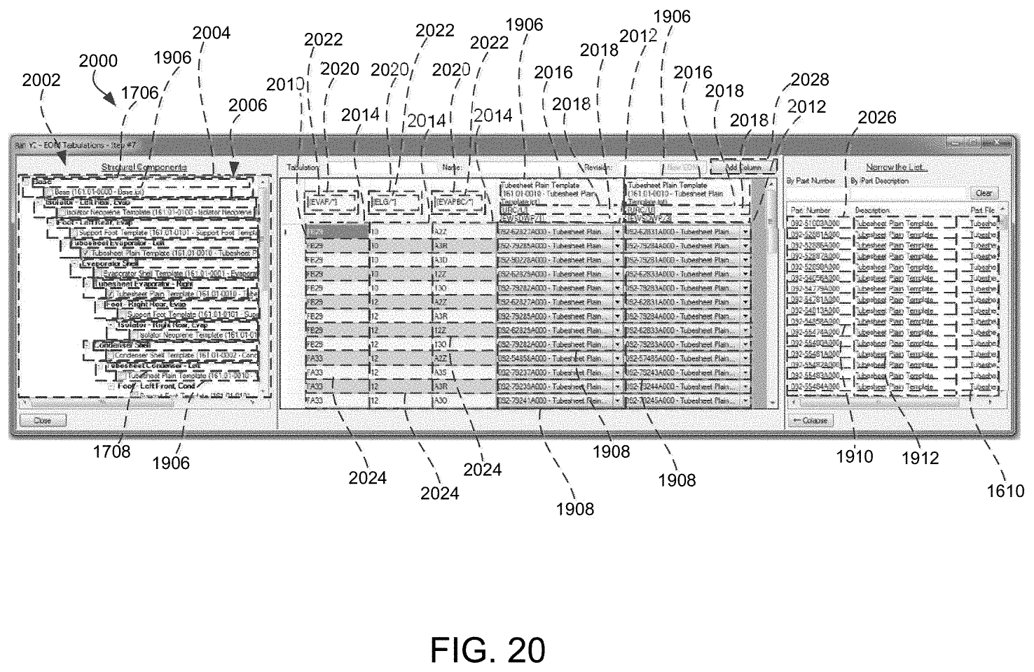

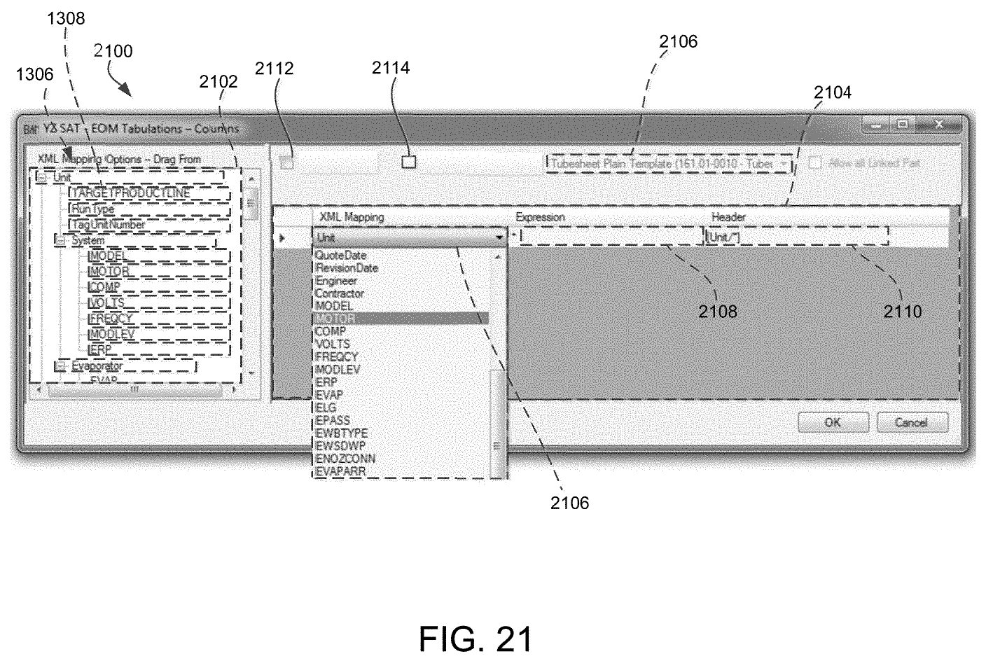

Configuration user interface 1200 also includes EOM tabulation button 1214, according to an exemplary embodiment. In response to receiving a selection of EOM tabulation button 1214, BIM formation system 500 defines which components are utilized at which times during the process 600. This process is described in more detail in FIGS. 20 and 21.

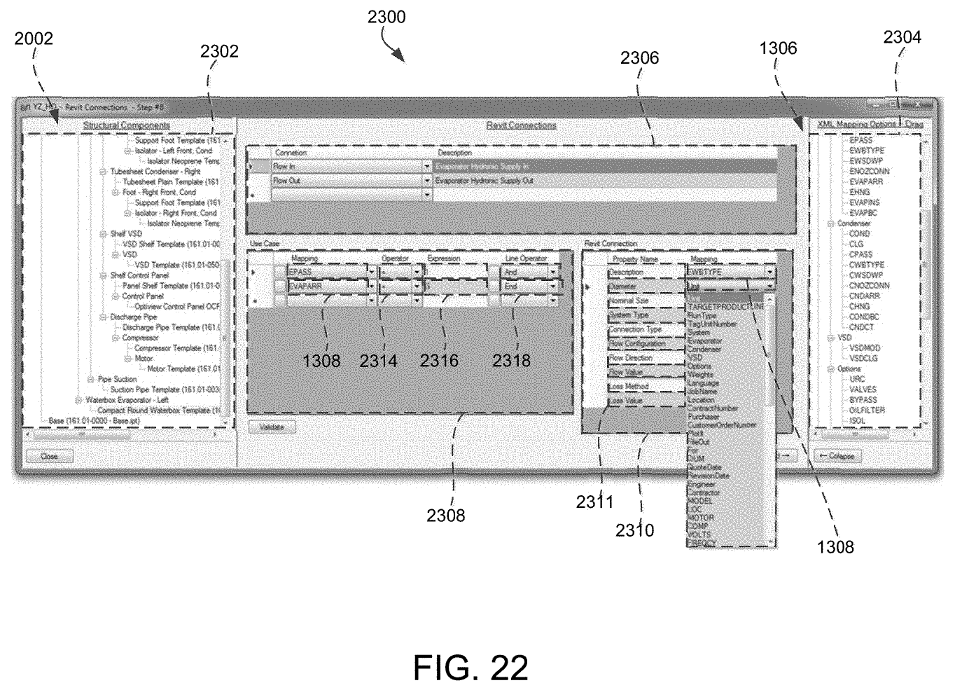

Configuration user interface 1200 also includes a connection button 1216, according to an exemplary embodiment. In response to receiving a selection of connection button 1216, BIM formation system 500 specifies component locations of connection elements used in Revit. This process is described in more detail in FIG. 22.

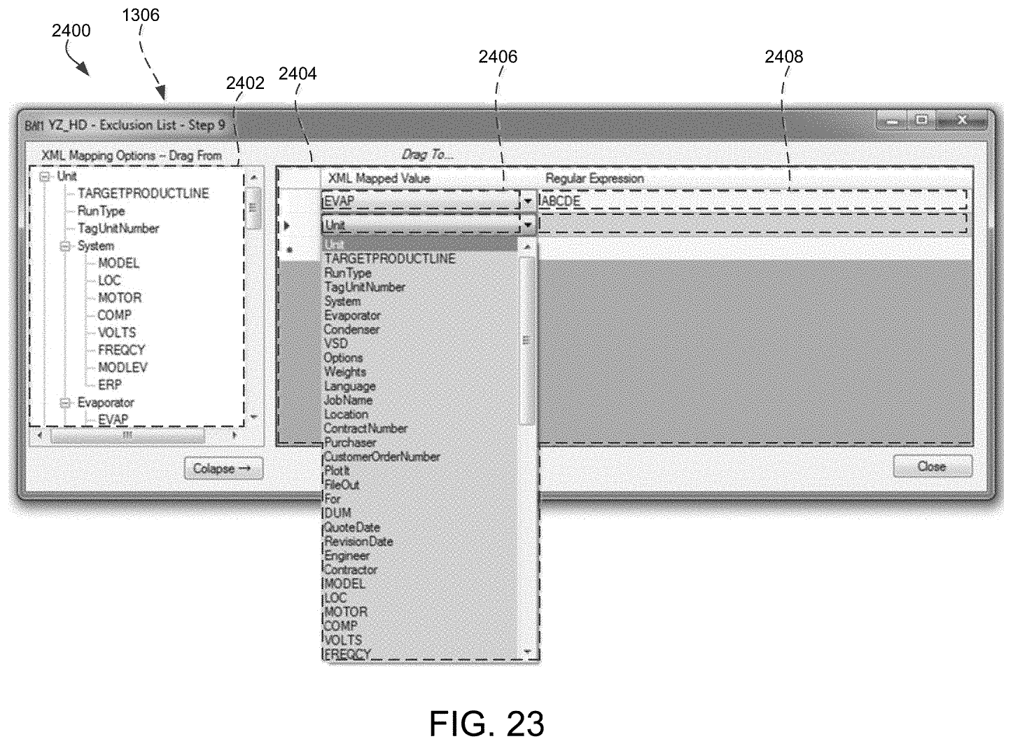

Configuration user interface 1200 also includes an exclusion button 1218, according to an exemplary embodiment. In response to receiving a selection of exclusion button 1218, BIM formation system 500 excludes the construction of component files that are not supported. This process is described in more detail in FIG. 23.

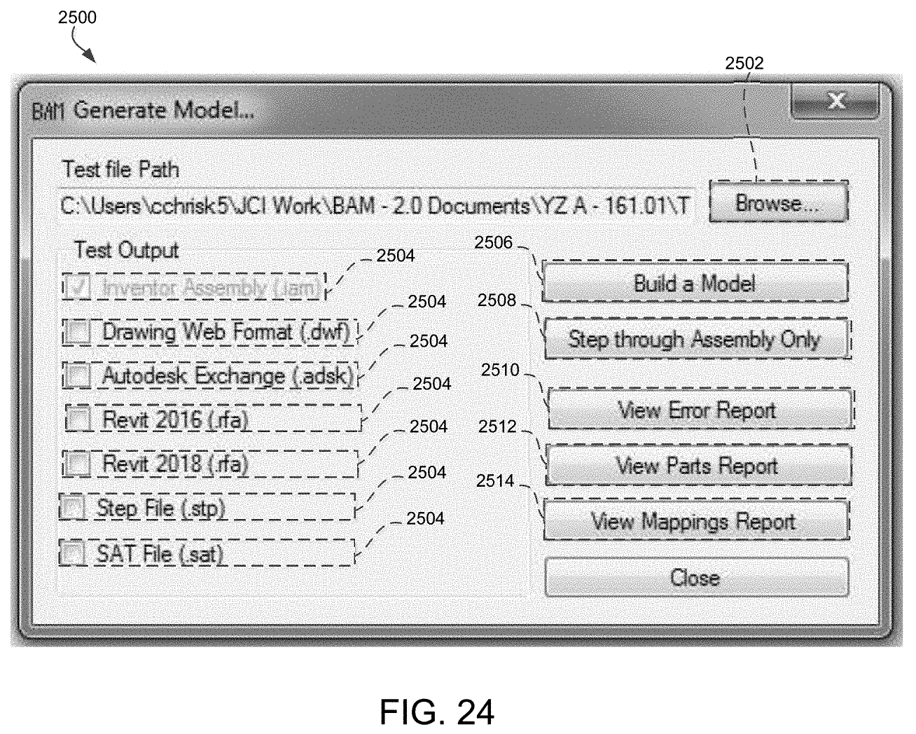

Configuration user interface 1200 also includes a test button 1220, according to an exemplary embodiment. In response to receiving a selection of test button 1220, BIM formation system 500 retrieves an .xml input file and attempts to create the component file associated with the .xml input file. A report outlining any errors or conflicts is also prepared and published in response to receiving the selection of test button 1220. This process is described in more detail in FIG. 24.

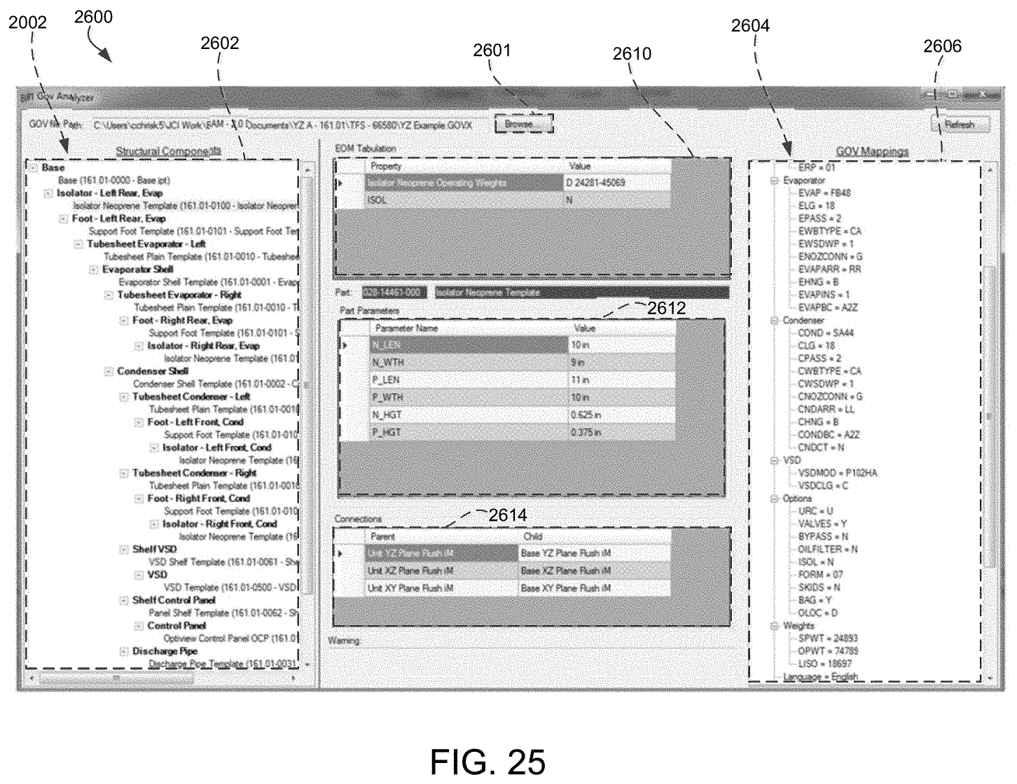

Configuration user interface 1200 also includes an analyzer button 1222, according to an exemplary embodiment. In response to receiving a selection of analyzer button 1222, BIM formation system 500 breaks out the .xml input file to show parameters and structure associated with the database used by BIM formation system 500. This process is described in more detail in FIG. 25.

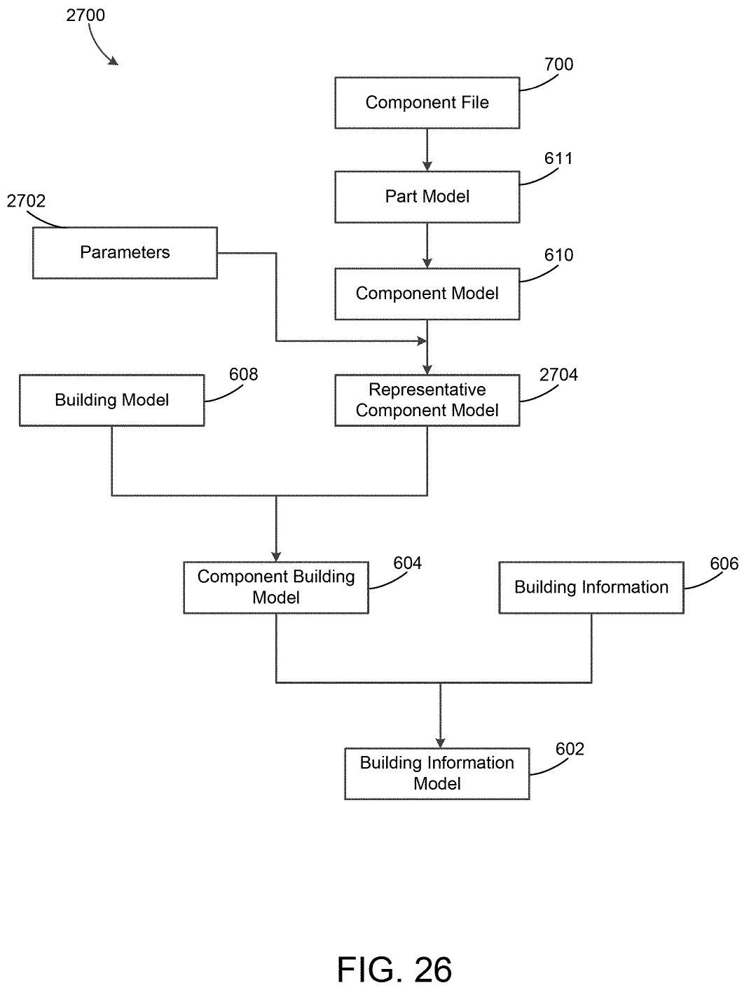

Configuration user interface 1200 also includes a release button 1224, according to an exemplary embodiment. In response to receiving a selection of release button 1224, BIM formation system 500 releases the component file for by BIM formation system 500. This process is described in more detail in FIG. 26.

Configuration user interface 1200 also includes a save button 1226, a close all button 1228, and a close button 1230, according to an exemplary embodiment. In response to receiving a selection of save button 1226, BIM formation system 500 saves all current information. In response to receiving a selection of close all button 1228, BIM formation system 500 closes all user interfaces. In response to receiving a selection of close button 1230, BIM formation system 500 closes configuration user interface 1200.

Referring now to FIG. 13, a mapping user interface 1300 is shown, according to an exemplary embodiment. Mapping user interface 1300 is provided to the user in response to receiving a selection of .xml mapping button 1204. Mapping user interface 1300 may be provided on top of or simultaneously with configuration user interface 1200. Mapping user interface 1300 facilitates mapping of .xml nodes to codes used throughout process 600. As a result, .xml nodes are linked to the component model.

Mapping user interface 1300 includes an import button 1302, according to an exemplary embodiment. In response to receiving a selection of import button 1302, BIM formation system 500 determines a structure 1304 from an .xml file and displays a structure tree 1306 corresponding to structure 1304 within a mapping user interface structure tree pane 1307 of mapping user interface 1300. Structure tree 1306 includes a plurality of .xml nodes 1308 and their relationship to other .xml nodes 1308 in forming structure 1304. Structure 1304 and .xml nodes 1308 are displayed on structure tree 1306 with their names and toggle boxes (e.g., check mark boxes, etc.) which enable structure 1304 and/or various .xml nodes 1308 to be hidden. Names of .xml nodes 1308 may be edited by clicking on .xml nodes 1308 in mapping user interface structure tree pane 1307. Each .xml node 1308 has an .xml node value as stored in the .xml file. The .xml node values are not displayed in mapping user interface 1300.

Mapping user interface 1300 also includes a conditional feature expression editor 1310 displayed within a conditional feature expression pane 1312 of mapping user interface 1306. Conditional feature expression editor 1310 operates to translate .xml node values for each .xml node 1308 into conditional feature values for conditional features 1311 (as described in FIG. 20) using constants or calculations. Conditional feature expression pane 1312 is populated immediately (e.g., based upon receipt and recognition of .xml nodes 1308, etc.) or upon a selection of .xml node 1308 having an .xml node value which is used to determine a value for at least one conditional feature 1311.

Mapping user interface 1300 also includes a conditional feature value editor 1314 displayed within a conditional feature calculation pane 1316 of mapping user interface 1306. Conditional feature value editor 1314 enables the user to change conditional feature values 1313 that will be assigned to each conditional feature 1311 if a calculation 1315 using .xml node values is satisfied. Conditional feature calculation pane 1316 is populated based upon a selection of conditional feature 1311 in conditional feature expression pane 1312 or upon a selection of .xml node 1308 having an .xml node value which is used in a calculation 1315 for at least one conditional feature 1311. For example, the user can simply type in new values 1313. Use of conditional feature value editor 1314 may be particularly advantageous where values 1313 for conditional features 1311 do not match features, options, or EOM codes.

Calculations 1315 may be changed by first being selected by the user. In response to receiving a selection of a calculation 1315, a calculation user interface 1400 is displayed. Calculation user interface 1400 may be provided on top of or simultaneously with configuration user interface 1200 and/or mapping user interface 1300.

Calculation user interface 1400 includes at least one calculation line 1402, each calculation line 1402 including a first parenthesis toggle 1404, a mapped tag 1406, a mapped tag operator 1408, an expression 1410, a second parenthesis toggle 1412, and a line operator 1414. Each calculation line 1402 represents a different calculation that factors into determining value 1313 for the selected conditional feature 1311. Some conditional features 1311 may have values 1313 that are determined by a plurality of calculation lines 1402 while others may have values 1313 that are determined by only one calculation line 1402. Calculation lines 1402 are interpreted from left to right, and from top to bottom. Calculation lines 1402 are combined according to this interpretation to form a single calculation for value 1313 of the selected conditional feature 1311.

First parenthesis toggle 1404 and second parenthesis toggle 1412 are each operable between a first state, where no parenthesis is included in calculation line 1402, and a second state, where a parenthesis is included in calculation line 1402. First parenthesis toggle 1404 and second parenthesis toggle enable a user to set an order of operations for each calculation line 1402 relative to other calculation lines 1402.

Mapped tag 1406 enable the user to select a specific .xml node name for one of .xml nodes 1308 using a dropdown list. Similarly, mapped tag operator 1408 enables the user to select a specific operator (e.g., equals, less than, greater than, less than or equal to, greater than or equal to, constant, RE, etc.) using a dropdown list. In an example, FIG. 14 illustrates a first mapped tag 1406 being “DUM” (e.g., .xml node 1308 having an .xml node name of “DUM”). Calculation user interface 1400, as shown in FIG. 14, creates a calculation 1315 where: (i) if an .xml node name of an .xml node 1308 is “DUM” and a .xml node value of that .xml node 1308 is equal to “M” (e.g., per the .xml file, etc.), and the .xml node name of another .xml node 1308 is “OPWT” and a .xml node value of that .xml node 1308 is greater than “0” and the .xml node value of that .xml node 1308 is less than or equal to 7422; or (ii) a .xml node name of an .xml node 1308 is “DUM” and a .xml node value of that .xml node 1308 is equal to “E”, and the .xml node name of another .xml node 1308 is “OPWT” and a .xml node value of that .xml node 1308 is greater than “0” and the .xml node value of that .xml node 1308 is less than or equal to 16363; then the value 1313 of conditional feature 1311 “Isolator Neoprene Operating Weights” is “A 0-7422.” Similar calculations 1315 are shown in FIG. 13 for setting value 1313 of conditional feature 1311 based upon other calculations 1315 being true (e.g., based upon .xml node values of other .xml nodes, etc.).

Mapped tag operator 1408 may also include date now stamp and date and time now stamp, both of which are append the mapped tag with additional information (e.g., date stamp, date and time stamp, etc.). Expression 1410 enables the user to enter a specific expression (e.g., a variable, a specific number, etc.). Line operator 1414 enables a user to select a specific logic operator (e.g., and, or, end, if, elseif, RE, etc.). After filling out the calculation lines 1402 as desired, the user then selects the “OK” button to close the calculation user interface 1400 and return to the mapping user interface 1300. After the user has edited the values 1313 for each conditional feature 1311 as desired, the user presses the close button on the mapping user interface 1300 to return to the configuration user interface 1200. If the user did not wish to edit the calculation lines 1402 on the calculation user interface 1400, the user may also select a close button, rather than the “OK” button, to return to the mapping user interface 1300.

Referring now to FIG. 15, a metadata user interface 1500 is shown, according to an exemplary embodiment. Metadata user interface 1500 is provided to the user in response to receiving a selection of metadata button 1206. Metadata user interface 1500 may be provided on top of or simultaneously with configuration user interface 1200. Metadata user interface 1500 facilitates association of metadata (e.g., data specific to a customer's order, etc.) with .xml nodes 1308.

Metadata user interface 1500 includes at least one metadata line 1502 displayed within a metadata line pane 1504. Each metadata line 1502 includes a metadata name 1506, a metadata group 1508, a metadata type 1510, an instance selection 1512, and a mapped .xml node selection 1514. Metadata name 1506 is defined by the creator of the metadata. Metadata group 1508 and metadata type 1510 may each be selected by the user via a dropdown list. By selecting the appropriate metadata group 1508 and metadata type 1510, the user facilitates accurate mapping of metadata line 1502 to an .xml node 1308. Instance selection 1512 enables a user to indicate whether metadata line 1502 is an instance. Mapped .xml node selection 1514 enables the user to select an .xml node 1308 to map metadata line 1502 to. Mapped .xml node selection 1514 may provide a list of .xml nodes 1308 via a dropdown list.

In some embodiments, metadata user interface 1500 includes an .xml node pane 1516 which displays structure tree 1306 and therefore .xml nodes 1308. Using .xml node pane 1516, a user may drag a .xml node from .xml node pane 1516 to a metadata line 1502, and vice versa, to cause an association between metadata line 1502 and .xml node 1308 to be formed.

Referring now to FIG. 16, a component file behavior user interface 1600 is shown, according to an exemplary embodiment. Component file behavior user interface 1600 is provided to the user in response to receiving a selection of model button 1202. Component file behavior user interface 1600 may be provided on top of or simultaneously with configuration user interface 1200. Component file behavior user interface 1600 facilitates management of component files 700 and identifies which component files 700 have connection elements to other component files 700 or to building models 608

In some instances, a component file needs to be added to component files 700. For example, where a component file has changed or added, it should be added to component files 700. Component file behavior user interface 1600 includes an import button 1602 and a synchronization button 1604. Component file behavior user interface 1600 is configured to import a component file from a source (e.g., local drive, external hard drive, network connection, etc.) to BIM formation system 500 in response to receiving a selection of import button 1602 and a subsequent selection of the source and component file. Component file behavior user interface 1600 is configured to synchronize component files 700 stored on BIM formation system 500 with a server storing component files in response to receiving a selection of synchronization button 1604. Through synchronization button 1604, new component files may be uploaded to the server (e.g., by engineers designing the components, etc.) and automatically downloaded by BIM formation system 500 and stored within component files 700.

Component file behavior user interface 1600 also includes a component file pane 1606. Component file pane 1606 includes at least one component file entry 1608 corresponding to component file 700 (e.g., a component file that was uploaded to, or downloaded by, BIM formation system 500, etc.).

Each component file entry 1608 includes a component file name 1610, a component file description 1612, a clearance area toggle 1614, a component file upload button 1616, a component file status 1618, a view reference button 1620, a reference upload button 1622, and a reference status 1624. Component file name 1610 is the name for the file for component file 700 (e.g., 161.01.0000—Base.ipt, etc.). Component file names 1610 for each of the component files 700 are unique and are not included in component file entries 1608 corresponding to different component files 700. Component file descriptions 1612 are short descriptions of component files 700 intended to make use of component file behavior user interface 1600 easier for users. Component file descriptions 1612 need not be unique among component file entries 1608.

Some component files 700 are clearance zones which are not models of a particular piece of building equipment but are models of an area around a particular piece of building equipment which must remain clear (e.g., where another piece of building equipment cannot be located, etc.). If a component file entry 1608 corresponds to a clearance zone, the user may select clearance area toggle 1614 to indicate as such.

Component file behavior user interface 1600 is configured to facilitate uploading or updating of component files 700 using component file upload button 1616. For example, when component file upload button 1616 for component file entry 1608 is selected, component file behavior user interface 1600 may facilitate uploading of a new component file to component files 700 and then may delete the now outdated component file 700.

BIM formation system 500 may compare component files 700 to other component files not stored within BIM formation system 500 to determine if component files 700 are up to date or need to be checked for updates. If, for example, BIM formation system 500 determines that a component file 700 for a component file entry 1608 is up to date, component file status 1618 for component file entry 1608 will indicate no update is necessary (e.g., “Same,” “No Updated Needed,” etc.). If, however, BIM formation system 500 determines that a component file 700 for a component file entry 1608 is not up to date, component file status 1618 for component file entry 1608 will indicate an update is necessary (e.g., “Newer,” “Out of Date,” “Outdated,” etc.). Furthermore, if BIM formation system 500 determines that a component file 700 for a component file entry 1608 can't be found outside of BMS formation system 500, component file status 1618 for component file entry 1608 will indicate no other component file could be found (e.g., “None,” “N/A,” etc.).

Component file behavior user interface 1600 is also configured to selectively provide a user with a two-dimensional (2D) file associated with a component file entry 1608. In this way, a user can rapidly view top, bottom, front, back, right, left, and perspective views of a component without having to generate the 2D file from an associated component file 700. View reference button 1620 is populated when a 2D file for component file entry 1608 is available. If a 2D file for component file entry 1608 is available, component file behavior user interface 1600 is configured to display the 2D file to the user in response to receiving a selection of view reference button 1620. View reference upload button 1622 enables a user to upload a 2D file to component files 700 so that the 2D file can be viewed using view reference button 1620. In response to view reference upload button 1622 being selected, component file behavior user interface 1600 may facilitate uploading of a 2D file to component file 700. Reference status 1624 may indicate whether a 2D file for component file entry 1608 is available for viewing. If, for example, BIM formation system 500 determines that a 2D file for a component file entry 1608 is not included in component files 700, reference status 1624 will indicate that no 2D file is available (e.g., “None,” “N/A,” etc.). If, however, BIM formation system 500 determines that a 2D file for a component file entry 1608 is included in component files 700, BIM formation system 500 determines if the 2D file is outdated. If BIM formation system 500 determines that the 2D file stored in component files 700 is not outdated, reference status 1624 for component file entry 1608 will indicate that no update is necessary (e.g., “Same,” “No Updated Needed,” etc.). If, however, BIM formation system 500 determines that the 2D file stored in component files 700 is not up to date, reference status 1624 for component file entry 1608 will indicate an update is necessary (e.g., “Newer,” “Out of Date,” “Outdated,” etc.). Furthermore, if BIM formation system 500 determines that a 2D file for a component file entry 1608 can't be found outside of BIM formation system 500, reference status 1624 for component file entry 1608 will indicate no other component file could be found (e.g., “None,” “N/A,” etc.).

Component file behavior user interface 1600 also includes a parameter pane 1626 and a parameter editor 1628 within parameter pane 1626. Parameter editor 1628 enables the user to change a parameter name 1630, a parameter comment 1632, and a parameter unit 1634 for each parameter 1636 in a component file 700 for a selected component file entry 1608. In other words, parameter editor 1628 is repopulated each time a different component file entry 1608 is selected.

Parameter name 1630 may be a name by which parameter 1636 is referenced within various codes and scripts or within part models 611. In order to ensure proper operation of BIM formation system 500, the user should ensure parameter names 1630 match codes, scripts, and part models 611. In various embodiments, parameter names 1630 are in all capital letters without spaces. If desired, the user can select parameter names 1630 and edit parameter names 1630.

Parameter comments 1632 may be notes and other shorthand intended to assist the user and other users in rapidly understanding the relevance of parameters 1636. If desired, the user can select parameter comments 1632 and edit parameter comments 1632.

Parameter units 1634 may be units (e.g., inches, feet, meters, centimeters, gallons per minute, cubic feet per minute, Watts, Volts, etc.) associated with parameters 1636 as saved within part models 611. If desired, the user can select parameter units 1634 and edit parameter units 1634.

Component file behavior user interface 1600 also includes a connection pane 1638 and a connection editor 1640 within connection pane 1638. Connection editor 1640 enables the user to change a connection name 1642, a connection type 1644, and a connection edges button 1646 for each connection 1648 in a component file 700 for a selected component file entry 1608. In other words, connection editor 1640 is repopulated each time a different component file entry 1608 is selected. Connections 1648 provide increased depth of understanding and knowledge to component files 700. For example, connections 1648 may facilitate calculation of flow rates within part models 611 or component models 610 derived from component files 700, optimized sizing of part models 611 or component models 610 derived from component files 700, calculation of capacities of part models 611 or component models 610 derived from component files 700, and other similar attributes.

Connection name 1642 may be a name by which connection 1648 is referenced within various codes and scripts or within other part models 611. In order to ensure proper operation of BIM formation system 500, the user should ensure connection names 1642 match codes, scripts, and other part models 611. In various embodiments, connection names 1642 are in all capital letters without spaces. If desired, the user can select connection names 1642 and edit connection names 1642.

Connection types 1644 may be a way of categorizing connections 1648 according to traits comment to other similar connectors 1648. For example, connection types 1644 may include “PIPE,” “ELECTRICAL,” “POTABLE,” “NON-POTABLE,” “NATURAL GAS,” “LP,” “AIR RETURN,” “AIR SUPPLY,” and other similar names. Connection types may be identical to those available in a software for forming part models 611 or component models 610 derived from component files 700, such as Revit. Connection types 1644 may be imported from component files 700 and may be selected by a user using a dropdown list.

Connection edges 1646 may be a way of identifying edges of component file 700 along which connections other component files 700 occur. If desired, the user can select connection edges 1646 and edit connection edges 1646.

Referring now to FIG. 17, a component file assembly user interface 1700 is shown, according to an exemplary embodiment. Component file assembly user interface 1700 is provided to the user in response to receiving a selection of component file assembly button 1210. Component file assembly user interface 1700 may be provided on top of or simultaneously with configuration user interface 1200. Component file assembly user interface 1700 facilitates association of component files 700 into groups.

Component files 700 in these groups are assembled into part model 611. By recording the associations, component file assembly user interface 1700 provides a mechanism for validating BIM formation system 500 by comparing part model 611 assembled by the user with the part model 611 determined by BIM formation system 500. Furthermore, component file assembly user interface 1700 provides a structure to assist an end user (different from the user of BIM formation system 500) in configuring the component in real life.

Component file assembly user interface 1700 includes a component file assembly tree 1702 displayed in a component file assembly tree pane 1704. Component file assembly tree 1702 includes a component file base assembly entry 1706 associated with a component file 700. In many applications, component file 700 associated with component file base assembly entry 1706 is a base (root) component which include includes iMate planes and is only used to serve as a base for orienting other component files 700 during assembly.

Component file assembly tree 1702 also includes at least one component file assembly entry 1708, each component file assembly entry 1708 associated with a component file 700. Component file assembly entries 1708 represent component files 700 that are in some way related to the component file 700 associated with component file base assembly entry 1706. Collectively, component file assembly tree 1702 provides a visual association of all component files 700 that will form part models 611 which will be assembled to form component model 610.

A user may examine component file assembly tree 1702 and, by right clicking on a component file assembly entry 1708, add, delete, move up, move down, or rename, component file assembly entry 1708 such that component file assembly tree 1702 accurately reflects a target component file 700. Component file assembly tree 1702 may include component file assembly entries 1708 corresponding to optional configurations of the target component model 610 (i.e., it is understood that the component model 610 may be constructed without each component file 700 associated with each component file assembly entry 1708, etc.).

After the user has properly configured the component file assembly tree 1702 for the component model 610, the user then has to ensure that each component file assembly entry 1708 corresponds to all appropriate component files 700. By left clicking on a component file assembly entry 1708, a component file assembly linking pane 1710 of component file assembly user interface 1700 and a component file assembly list pane 1712 of component file assembly user interface 1700 are populated based on the component file assembly entry 1708. Specifically, component file assembly linking pane 1710 includes at least one component file assembly list pane information entry 1714 that is populated with component file description 1612 and component file name 1610 for at least one component file 610 associated with the selected component file assembly entry 1708. Component file assembly list pane 1712 may be populated at least one component file assembly list pane entry 1714. Each component file assembly list pane entry 1714 includes component file name 1610 and component file description 1612 for component modes 610 which is not yet associated with the selected component file assembly entry 1708.

The user then sifts through the component file assembly list pane entries 1714 to determine if any should be associated with the selected component file assembly entry 1708. If so, the user selects the component file assembly list pane entry 1714 and drags it into component file assembly linking pane 1710, this causes component file 700 associated with the component file assembly list pane entry 1714 to be associated with the target component file 700 illustrated by component file assembly tree 1702. It is understood that some component files 700, such as those for more basic or underlying files, may be used to assembly more than one part model 611 and/or more than one component model 610 and therefore may be associated with more than one component file assembly tree 1702. The component file assembly list pane entries 1714 may be sortable by component file description 1612 and component file name 1610.

Component file assembly user interface 1700 also includes a related components pane 1715 and a constraints pane 1716. Related components pane 1715 includes at least one relation entry 1718. Each relation entry 1718 includes a parent component file name 1720, a child component file name 1722, and an alter constraints button 1724.

Upon selection of component file assembly entry 1708, related components pane 1715 is populated based on component file assembly entry 1708. Specifically, related components pane 1715 is populated with component file description 1612 and component file name 1610 for each component file 700 that is a parent of component file 700 associated with the selected component file assembly entry 1708 as well as with component file description 1612 and component file name 1610 of component file 700 associated with the selected component file assembly entry 1708. In this way, related components pane 1715 lists the relationships between component files 700 in a way which can rapidly be reviewed by the user. In some embodiments, parent component file name 1720 provides a dropdown list of component file descriptions 1612 and component file names 1610 and child component file name 1722 also provides a dropdown list of component file descriptions 1612 and component file names 1610. In these embodiments, relationships between component files 700 may be established by the user by selecting component file names 1610 and/or component file descriptions 1612 in each dropdown list (of parent component file name 1720 and child component file name 1722).

In response to receiving a selection of parent component file name 1720 or child component file name 1722, constraints pane 1716 may be populated with at least one parent constraint name 1726 (e.g., XY Plane Flush, XZ Plane Flush, YZ Plane Flush, etc.) and at least one child constraint name 1728 (e.g., XY Plane Flush, XZ Plane Flush, YZ Plane Flush, etc.). Each parent constraint name 1726 explains the constraint in component file 700 associated with the parent component file name 1720 relative to the component file 700 associated with the child component file name 1722. Similarly, each child constraint name 1728 explains the constraint in component file 700 associated with the child component file name 1722 relative to the component file associated with the parent component file name 1720.

After reviewing constraints pane 1716, a user may select alter constraints button 1724 if changes to the constraints are desired. In response to receiving a selection of alter constraints button 1724, a constraints user interface 1800 is provided to the user. Constraints user interface 1800 may be provided on top of or simultaneously with component file assembly user interface 1700 and/or configuration user interface 1200.

Constraints user interface 1800 is populated with parent constraint name lists 1802 and child constraint name lists 1804. Each parent constraint name list 1802 includes parent constraint names 1726 and each child constraint name list 1804 contains child constraint names 1728. Parent constraint name lists 1802 and child constraint name lists 1804 may each be provided as dropdown lists.

After using each parent constraint name list 1802 and child constraint name list 1804 to generate combinations of parent constraint names 1726 and child constraint names 1728 that are desirable, the user then may select a test constraints button 1806. Test constraints button 1806 opens part models 611 and/or component models 610 with the constraints specified by patent constraint names 1726 and child constraint names 1728 and enables the user to manipulate part models 611 and/or component models 610 to determine if part models 611 and/or component models 610 are properly constrained or if additional constraints, or fewer constraints, are desired. At least three constraints for both the parent and child are required for part models 611 and component models 610 to be fully constrained.

After the user is satisfied with the constraints, the user may press the “OK” button or “Cancel” button to close constraints user interface 1800. Similarly, after the user has established all appropriate relationships between component files 700, the user may press the “Close” button on component file assembly user interface 1700 to close component file assembly user interface 1700.

Referring now to FIG. 19, a part definitions user interface 1900 is shown, according to an exemplary embodiment. Part definitions user interface 1900 is provided to the user in response to receiving a selection of part definitions button 1212. Part definitions user interface 1900 may be provided on top of or simultaneously with configuration user interface 1200. Part definitions user interface 1900 facilitates formations of part models 611 based on component files 700 where each part model 611 is assembled to construct component model 610 for the target component.

Part definitions user interface 1900 includes a file pane 1902 and a parts pane 1904. File pane 1902 is populated with at least one file entry 1906. File pane 1902 includes one file entry 1906 corresponding to component file base assembly entry 1706 and one file entry 1906 corresponding to each component file assembly entry 1708. Each file entry 1906 includes component file description 1612 and component file name 1610 for at least one component file 700 associated with component file assembly entry 1708 which is associated with file entry 1906.

Each file entry 1906 is configured to be selected by the user. Selection of file entry 1906 causes parts pane 1904 to be populated with at least one part model entry 1908, each part model entry 1908 corresponding to a part file 611. Each part model entry 1908 may include a part number 1910, a description 1912, and at least one parameter 1914. Part numbers 1910 are unique across all part model entries 1908 such that part model entries can be sorted by part number 1910. Part model entries 1908 are configured to facilitate entry of information by the user (e.g., the user can enter part numbers 1910, etc.). Part definitions user interface 1900 also includes a reference file button 1916. When a file entry 1906 is selected and reference file button 1916 is selected, a 2D file (e.g., as uploaded via component file behavior user interface 1600, etc.) corresponding to file entry 1906 is provided to the user. After the user has created part model entries 1908 for each file entry 1906, the user may press a “Close” button to close part definitions user interface 1900.

Referring now to FIG. 20, an EOM tabulation user interface 2000 is shown, according to an exemplary embodiment. EOM tabulation user interface 2000 is provided to the user in response to receiving a selection of EOM tabulation button 1214. EOM tabulation user interface 2000 may be provided on top of or simultaneously with configuration user interface 1200. EOM tabulation interface 2000 defines circumstances under which part file 611 is called for in constructing component model 610 based upon specific options for a given feature of a target component associated with component model 610.

EOM tabulation user interface 2000 includes a merged tree 2002 displayed in an EOM tabulation user interface merged tree pane 2004. Merged tree 2002 includes a merged tree base 2006. Merged tree base 2006 includes component file base assembly entry 1706 and file entry 1906 associated with component file base assembly entry 1706. Merged tree 2002 also includes at least one merged tree entry 2008. Each merged tree entry 2008 includes component file assembly entry 1708 and file entry 1906 associated with component file assembly entry 1708.

A user may select merged tree base 2006 or merged tree entries 2008. In response to receiving a selection of merged tree base 2006 or merged tree entries 2008, EOM tabulation user interface 2000 populates a tabulation pane 2010 with information specific to merged tree base 2006 or merged tree entry 2008. Additionally, checkboxes next to merged tree base 2006 or merged tree entries 2008 may appear in response to receiving a selection of merged tree base 2006 or merged tree entries 2008. Checkboxes indicate that the information in tabulation pane 2010 is common to all merged tree base 2006 and merged tree entries 2008 having a checkbox.

Tabulation pane 2010 includes at least one part column 2012 and may include at least one feature column 2014. Each part column 2012 includes a part column header 2016. Each part column header 2016 includes file entry 1906 associated with the selected merged tree base 2006 or merged tree entry 2008. Each part column header 2016 also includes at least one unconditional feature 2018. Each unconditional feature 2018 is associated with file entry 1906 in the same column header 2016 and represents a non-optional feature of component file 610 associated with file entry 1906.

Each part column header 2016 is associated with at least one part model entry 1908 associated with the same file entry 1906 contained within part column header 2016. Unconditional features 2018 are common among all part model entries 1908 in the same part column 2012. As such, unconditional features 2018 serve to distinguish part model entries 1908 in one part column 2012 from part model entries 1908 in another part column 2012.

Each feature column 2014 includes a feature column header 2020. Each feature column header 2020 includes at least one conditional feature 2022. In some applications, conditional features 2022 are different from unconditional features 2018. In some applications, conditional features 2022 include conditional features 1311. Each feature column 2014 includes at least one option entry 2024 associated with conditional features 2022 in feature column header 2020. Each feature column 2014 may include a plurality of the same option entries 2024 and/or a plurality of different option entries 2024.

Unconditional features 2018 and conditional features 2022 are given in the form “X/Y” where “X” is the overarching option (e.g., evaporators, etc.) and “Y” is the specific option (e.g., evaporators with a specific configuration, etc.). In some applications, “Y” is given as “*” to indicate that unconditional feature 2018 or condition feature 2022 applies for all “X” regardless of “Y.”

Part columns 2012 and feature columns 2014 facilitate identification of a specific part model entry 1908. Specifically, given identification of a target part model 611, BIM formation system 500 can identify the appropriate file entry 1906 and therefore the list of possible part model entries 1908, then select the appropriate part model entry 1908 by comparing the features of the target part model 611 to unconditional features 2018 and conditional features 2022, and then provide the user with part number 1910, description 1912, and/or at least one parameter 1914 associated with the appropriate part model entry 1908. For example, where the target part model 611 has features EVAP=FB29, ELG=10, EVAPBC=A2Z, URC=U, and EWSDWP=1, a part number 1910 of “092-62827A000” is provided to the user. Parameters 1914 are utilized by BIM formation system 500 to construct part models 611 and/or component models 610.

Each part model entry 1908 in each part column 2012 for each row of option entries 2024 may be selected via a dropdown list from all part model entries 1908 associated with the target part model 611. Additionally, each part model entry 1908 may be dragged from a part model pane 2026 onto tabulation pane 2010 in the desired part column 2012 and row of option entries 2024. Part model pane 2026 is included in EOM tabulation user interface 2000. Part model pane 2026 displays part model entries 1908. In various embodiments, part model pane 2026 displays part number 1910, description 1912, and component file name 1610 for file entry 1906 associated with part model entry 1908.

EOM tabulation user interface 2000 also includes an add column button 2028. Referring now to FIG. 21, column user interface 2100 is shown, according to an exemplary embodiment. Column user interface 2100 is provided to the user in response to receiving a selection of add column button 2028. Column user interface 2100 may be provided on top of or simultaneously with EOM tabulation user interface 2000 and/or configuration user interface 1200. Column user interface 2100 facilitates addition of new part columns 2012 and feature columns 2014 to tabulation pane 2010.

Column user interface 2100 includes a column user interface structure tree pane 2102. Structure tree 1306, including .xml nodes 1308, is located within column user interface structure tree pane 2102. Column user interface 2100 also includes a mapping pane 2104. Mapping panel 2104 includes a column user interface .xml node input 2106. Column user interface .xml node input 2106 may include a drop down list of all .xml nodes 1308 in structure tree 1306. Additionally, column user interface .xml node input 2106 is configured to receive an .xml node 1308 dragged and dropped onto column user interface .xml node input 2106 from column user interface structure tree pane 2102. Column user interface .xml node input 2106 represents the “X” for an unconditional feature 2018 or a conditional feature 2022 in the column to be added.

Once column user interface .xml node input 2106 has been populated, the user must populate a column user interface expression input 2108. Column user interface expression input 2108 represents the “Y” for unconditional feature 2018 or conditional feature 2022 in the column to be added. For example, column user interface expression input 2108 may be “*.” Once column user interface expression input 2108 has been entered, column user interface 2100 populates an added column header 2110 based on column user interface .xml node input 2106 and column user interface expression input 2108. The user can repeat this process for multiple .xml nodes 1308 if desired.

After added column header 2110 has been determined, the user then determines whether the added column will be a part column 2012 or a feature column 2014. If the added column will be a part column 2012, the user may select part column option 2112. If the added column will be a feature column 2014, the user may select feature column option 2114.

Additionally, if the added column will be a part column 2012, column user interface 2100 displays, in response to receiving a selection of part column option 2112, a file entry input 2116. File entry input 2116 is configured to receive a selection of file entry 1906 in merged tree 2002 to associate with the added column. File entry input 2116 may include a dropdown list of all file entries 1906 in merged tree 2002.

After the user has added columns as desired, the user may close column user interface 2100 and navigate to EOM tabulation user interface 2000. If column user interface 2100 was used to add a part column 2012, the user must ensure that all part model entries 1908 within the added part column 2012 are properly associated with the appropriate option entries 2024. If column user interface 2100 was used to add a feature column 2014, the user must ensure that all part model entries 1908 for all part columns 2012 are properly associated with option entries 2024 in the added feature column 2014. After the user has ensured all part model entries 1908 are properly associated, the user may press a “Close” button to close EOM tabulation user interface 2000.

Referring now to FIG. 22, a connection user interface 2300 is shown, according to an exemplary embodiment. Connection user interface 2300 is provided to the user in response to receiving a selection of connection button 1216. Connection user interface 2300 may be provided on top of or simultaneously with configuration user interface 1200. Connection user interface 2300 defines location and attributes of connections for each file entry 1906.

Connection user interface 2300 includes merged tree 2002 displayed in a connection user interface merged tree pane 2302. Connection user interface 2300 also includes structure tree 1306 displayed in a connection user interface structure tree pane 2304. Connection user interface 2300 also includes a connection pane 2306, a use pane 2308, and a Revit pane 2310.

In response to receiving a selection of merged tree base 2006 or merged tree entry 2008, connection pane 2306 is populated with connection names 1642 and descriptions for each connection 1648 associated with component file 700 associated with merged tree base 2006 or merged tree entry 2008.

In response to receiving a selection of connection name 1642, Revit pane 2310 is populated with connection configuration information 2311 relating to connection name 1642. Connection configuration information 2311 may include a connection description, a diameter, a nominal size, a system type, a connection type, a flow configuration, a flow direction, a flow value, a loss method, and a loss value. Revit pane 2310 facilitates association of connection configuration information 2311 with .xml nodes 1308. .xml nodes 1308 may be provided via dropdown menus for any or all of configuration information 2311.

Also in response to receiving a selection of connection name 1642, use pane 2308 is populated with use conditions 2309 relating to connection name 1642. Use conditions 2309 define when connection 1648 associated with connection name 1642 is applied. Use conditions 2309 include .xml node 1308, a use operator 2314, a use expression 2316, and a use line operator 2318. As shown in FIG. 22, the “Evaporator Hydronic Supply In” connection will only be applied where the .xml node name of .xml node 1308 is “EPASS” and the .xml node value for .xml node 1308 is equal to “1” and where the .xml node name of another .xml node 1038 is “EVAPARR” and the .xml node value for that .xml node 1308 is equal to “G.”

When file entry 1906 is selected on merged tree 2002 displayed in connection user interface merged tree pane 2302, connection pane 2306, use pane 2308, and Revit pane 2310 may be populated.

After the user has defined location and attributes of connections for each file entry 1906, the user may press a “Close” button to close connection user interface 2300.

Referring now to FIG. 23, an exclusion user interface 2400 is shown, according to an exemplary embodiment. Exclusion user interface 2400 is provided to the user in response to receiving a selection of exclusion button 1218. Exclusion user interface 2400 may be provided on top of or simultaneously with configuration user interface 1200. Exclusion user interface 2400 defines .xml nodes 1308 that should be treated as an exception.

Exclusion user interface 2400 includes structure tree 1306 displayed in an exclusion user interface structure tree pane 2402. Exclusion user interface 2400 also includes an exclusion pane 2404.

Exclusion pane 2404 includes an exclusion user interface .xml node input 2406. Exclusion user interface .xml node input 2406 may include a drop down list of all .xml nodes 1308 in structure tree 1306. Additionally, exclusion user interface .xml node input 2406 is configured to receive an .xml node 1308 dragged and dropped onto exclusion user interface .xml node input 2406 from exclusion user interface structure tree pane 2402.

Exclusion pane 2404 also includes an exclusion user interface expression input 2408 which is a particular value for .xml node value of an .xml node 1308. After the user enters .xml node 1308 in exclusion user interface .xml node input 2406, the user must enter an expression in exclusion user interface expression input 2408 in order to create an exception for .xml node 1308. If an exception for .xml node 1308 is created, then .xml node 1308 is not modeled when exclusion user interface expression input 2408 is satisfied (e.g., when .xml node 1308 is a certain value, etc.). For example, as shown in FIG. 23, when .xml node 1308 having .xml node name “EVAP” is selected, .xml node 1308 will not be modeled when .xml node value for .xml node 1308 is equal to “ABCDE.”

After the user has defined exceptions for .xml nodes 1308 as desired, the user may press a “Close” button to close exclusion user interface 2400.

Referring now to FIG. 24, a testing user interface 2500 is shown, according to an exemplary embodiment. Testing user interface 2500 is provided to the user in response to receiving a selection of test button 1220. Testing user interface 2500 may be provided on top of or simultaneously with configuration user interface 1200. Testing user interface 2500 causes BIM formation system 500 to build component model 610 or attempt to build component model 610 and records any errors that arise from attempting to build component model 610.

Testing user interface 2500 includes a browse button 2502. Browse button 2502 enables the user to select a path for saving outputs from testing user interface 2500, such as component model 610. Testing user interface 2500 includes a plurality of output model buttons 2504. Each of the output model buttons 2504 instructs BIM formation system 500 to build component model 610 or attempt to build component model 610 in a different format (e.g., Inventor assembly (.iam), drawing web format (.dwf), Autodesk exchange (.adsk), Revit 2016 (.rfa), Revit 2018 (.rfa), Step file (.stp), SAT file (.sat), etc.). More than one output model button 2504 may be selected simultaneously (e.g., such that BIM formation system 500 builds component model 610 in more than one format, etc.). Additionally, some model buttons 2504 (e.g., a model button 2504 for Inventor assembly (.iam), etc.) may be selected by default.

Testing user interface 2500 also includes a build button 2506, a step through button 2508, an error report button 2510, a parts report button 2512, and a mapping report button 2514 that may be selected after at least one output model button 2504 is selected. In response to receiving a selection of build button 2506, testing user interface 2500 instructs BIM formation system 500 to build, or attempt to build, component model 610. If component model 610 is built, component model 610 will be saved at the path selected. If the component model 610 cannot be built, testing user interface 2500 may prompt the user.

In response to receiving a selection of step through button 2508, testing user interface 2500 may coordinate with BIM formation system 500 to cause a step through of a build, or an attempt to build, component model 610. For example, the user may be provided with still images in a successive order, each still image illustrating a step in the process of building component model 610.

In response to receiving a selection of error report button 2510, testing user interface 2500 may coordinate with BIM formation system 500 to cause an error report to be generated and saved to the selected path and/or displayed to the user. The error report may include any errors (e.g., due to constraints, due to mappings, due to associations, etc.) that BIM formation system 500 encountered in building or attempting to build component model 610.

In response to receiving a selection of parts report button 2512, testing user interface 2500 may coordinate with BIM formation system 500 to cause a parts report to be generated and saved to the selected path and/or displayed to the user. The parts report may include a listing (e.g., in tree format, in bill of materials (BOM) format, etc.) of all component files 700 and/or part models 611 in component model 610.

In response to receiving a selection of mapping report button 2514, testing user interface 2500 may coordinate with BIM formation system 500 to cause a mapping report to be generated and saved to the selected path and/or displayed to the user. The mapping report may include a listing (e.g., in tree format, etc.) of relationships between all component files 700 and/or part models 611 in component model 610.

After the user is finished, the user may press a “Close” button to close testing user interface 2500.

Referring now to FIG. 26, an analyzer user interface 2600 is shown, according to an exemplary embodiment. Analyzing user interface 2600 is provided to the user in response to receiving a selection of analyzer button 1222. Analyzer user interface 2600 may be provided on top of or simultaneously with configuration user interface 1200. Analyze user interface 2600 includes a browse button 2601. A user may utilize browse button 2601 to select component model 610.

Analyzer user interface 2600 includes merged tree 2002 displayed in an analyzer user interface merged tree pane 2602. Merged tree 2002 is displayed in response to receiving the user's selection of component model 610 via browse button 2601. Analyzer user interface 2600 also includes a mapped structure tree 2604 displayed in a mapped structure tree pane 2606. Mapped structure tree 2604 is displayed in response to receiving the user's selection of component model 610 via browse button 2601. Mapped structure tree 2604 is formed by BIM formation system 500 by modifying structure tree 1306 with expressions provided in column user interface expression input 2108 or provided by use pane 2308.

Analyzer user interface 2600 also includes an analyzer user interface EOM tabulation pane 2610, an analyzer user interface parameter pane 2612, and an analyzer user interface connection pane 2614. Analyzer user interface EOM tabulation pane 2610, analyzer user interface parameter pane 2612, and analyzer user interface connection pane 2614 are populated in response to receiving a user's selection of file entry 1906, component file base assembly entry 1706, or component file assembly entry 1708 in merged tree 2002. Analyzer user interface EOM tabulation pane 2610 may be populated with option entries 2024 and part model entries 1908 associated with the user's selection of file entry 1906, component file base assembly entry 1706, or component file assembly entry 1708 in merged tree 2002. Analyzer user interface parameter pane 2612 may be populated with parameters 1914 associated with the user's selection of file entry 1906, component file base assembly entry 1706, or component file assembly entry 1708 in merged tree 2002. Analyzer user interface connection pane 2614 may be populated with data from connections pane 2306 associated with the user's selection of file entry 1906, component file base assembly entry 1706, or component file assembly entry 1708 in merged tree 2002.

Analyzer user interface 2600 causes BIM formation system 500 to break down the structure of component model 610 and facilitates error-checking as component model 610 is generated. Error checking may be facilitated by the BIM formation system 500 highlighting portions of merged tree 2002 (e.g., file entry 1906 is highlighted green if there are no errors associated with file entry 1906, file entry 1906 is highlighted yellow is an error is associated with file entry 1906, etc.).

After the user is finished, the user may press a “Close” button to close analyzing user interface 2600.

After the user has utilized BISM formation system 500 to construct a component model 610, component model 610 is ready to be incorporated into a component building model 604 and BIM 602, as described in FIG. 6. In order for component model 610 to be incorporated into BIM 602, component model 610 first must be released. An administrator may go into initial application user interface 1000 and select the release option 1080 for component model 610 to make component model 610 available for incorporating into BIM 602.

Referring to FIG. 26, a block diagram of a modeling process 2700 is shown, according to an exemplary embodiment. First, component file 700 is created. 3D models 702 within component files 700 may be parametric. Next, part model 611 is created by assembling component files 700 to form part model 611. Part models 611 may be parametric. Next, component model 610 is created by assembling part models 611 to form component model 610. Component model 610 is parametric. Next, parameters 2702 are input into component model 610 to form a representative component model 2704. Representative component model 2704 is combined with building model 608 to form component building model 604. Component building model 604 is combined with building information 606 to form BIM 602.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements; values of parameters; mounting arrangements; use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, by a special purpose computer processor for an appropriate system incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

The background section is intended to provide a background or context to the invention recited in the claims. The description in the background section may include concepts that could be pursued but are not necessarily ones that have been previously conceived or pursued. Therefore, unless otherwise indicated herein, what is described in the background section is not prior art to the present invention and is not admitted to be prior art by inclusion in the background section.

What is claimed is:

1. A method for forming a building information model (BIM), the method comprising:
receiving, by a BIM formation system, an input from a user, the input having a building model, an indication of a target component, and a parameter of the target component;
selecting, by the BIM formation system, a component model associated with the target component;
inputting, by the BIM formation system, the parameter into the component model to form a representative component model associated with the target component; and
integrating, by the BIM formation system, the representative component model with the building model to form a component building model;
wherein the component model comprises at least one of:
a 3D model of the target component; or
a 2D image of the target component.

2. The method of claim 1, wherein the parameter comprises a dimension of the target component; and
wherein inputting the parameter into the component model comprises inputting the dimension into at least one parametric equation associated with the component model.

3. The method of claim 1, further comprising:
selecting, by the BIM formation system, a first component file;
selecting, by the BIM formation system, a second component file;
assembling, by the BIM formation system, the first component file and the second component file into a part model; and
assembling, by the BIM formation system, the component model from the part model;
wherein the first component file, the second component file, the part model, and the component model are each defined by at least one parametric equation.

4. The method of claim 1, wherein the representative component model comprises a first connection point;
wherein the building model comprises a second connection point; and
wherein integrating the representative component model with the building model comprises connecting the first connection point and the second connection point.

5. The method of claim 1, further comprising:
receiving, by the BIM formation system, building information associated with the building model; and
integrating the component building model and the building information to form a BIM.

6. A method for forming a representative component model using a building information model (BIM) formation system, the representative component model associated with a target component, the method comprising:
providing, by the BIM formation system, a first component model, the first component model having a dimension that is defined by a first parametric equation;
receiving, by the BIM formation system, a selection of the first component model;
receiving, by the BIM formation system, a first parameter associated with a first target component;
inputting, by the BIM formation system, the first parameter into the first parametric equation;
generating, by the BIM formation system, a first representative component model in response to the first parameter being input into the first parametric equation;
receiving, by the BIM formation system, a building model; and
integrating, by the BIM formation system, the first representative component model into the building model to form a first BIM.

7. The method of claim 6, further comprising:
receiving, by the BIM formation system, a second parameter associated with a second target component different from the first target component;
inputting, by the BIM formation system, the second parameter into the first parametric equation;
generating, by the BIM formation system, a second representative component model in response to the second parameter being input into the first parametric equation; and
integrating, by the BIM formation system, the second representative component model into the building model to form a second BIM.

8. The method of claim 6, further comprising:
providing, by the BIM formation system, a second component model, the second component model having a dimension that is defined by a second parametric equation;
receiving, by the BIM formation system, a selection of the second component model;
receiving, by the BIM formation system, a second parameter associated with a second target component;
inputting, by the BIM formation system, the second parameter into the second parametric equation;
generating, by the BIM formation system, a second representative component model in response to the second parameter being input into the second parametric equation; and
integrating, by the BIM formation system, the second representative component model into the building model to form the first BIM.

9. The method of claim 6, further comprising:
providing, by the BIM formation system, an initial application user interface having a configuration option associated with a second component model; and
providing, by the BIM formation system, a configuration user interface in response to receiving a selection of the configuration option, the configuration user interface operable to generate the second component model.

10. The method off claim 9, further comprising:
receiving, by the BIM formation system, a second parameter associated with a second target component different from the first target component; and
determining that the second component model is unavailable;
wherein the initial application user interface is provided by the BIM formation system in response to determining that the second component model is unavailable; and
wherein the second component model is associated with the second target component.

11. The method of claim 9, further comprising:
providing, by the BIM formation system, a component file behavior user interface associated with the second component model in response to receiving a selection of a model button provided on the configuration user interface; and
importing, by the BIM formation system, a component file associated with the second component model in response to receiving a selection of an import button provided on the component file behavior user interface.

12. The method of claim 9, further comprising:
providing, by the BIM formation system, a component file assembly user interface associated with the second component model in response to receiving a selection of a component file assembly button provided on the configuration user interface;
providing, by the BIM formation system, a component file assembly tree associated with the second component model, the component file assembly tree including:
a component file base assembly entry associated with a first component file;
a first component file assembly entry associated with a second component file configured to be assembled with the first component file; and
a second component file assembly entry associated with a third component file configured to be assembled with the first component file; and
facilitating, by the BIM formation system, rearrangement of the first component file assembly entry and the second component file assembly entry within the component file assembly tree.

13. The method of claim 12, wherein the component file assembly tree dictates an order in which the first component file, the second component file, and the third component file are assembled to form the second component model;
wherein the first component file is assembled to the second component file, and then the first component file and the second component file are assembled to the third component file when the second component file is located between the first component file and the third component file; and
wherein the first component file is assembled to the third component file, and then the first component file and the third component file are assembled to the second component file when the third component file is located between the first component file and the second component file.

14. The method of claim 12, further comprising providing, by the BIM formation system, a parent component name and a child component name on the component file assembly user interface in response to receiving a selection of the first component file assembly entry or the second component file assembly entry;
wherein the parent component name is associated with the component file base assembly entry; and
wherein the child component name is associated with the first component file assembly entry or the second component file assembly entry.

15. The method of claim 14, further comprising: providing, by the BIM formation system, a parent constraint name and a child constraint name on the component file assembly user interface in response to receiving a selection of the first component file assembly entry or the second component file assembly entry;
wherein the parent constraint name indicates a first constraint associated with the first component file, and between the first component file and the second component file or the third component file; and
wherein the child constraint name indicates a second constraint associated with the second component file or the third component file, and between the first component file and the second component file or the third component file.

16. A method for generating a component model using a building information model (BIM) formation system, the method comprising:
providing, by the BIM formation system, an initial application user interface having a configuration option associated with a component model;
providing, by the BIM formation system, a configuration user interface in response to receiving a selection of the configuration option, the configuration user interface operable to generate the component model and having a model button associated with the component model;
providing, by the BIM formation system, a component file behavior user interface associated with the component model in response to receiving a selection of the model button, the component file behavior user interface having an import button;
importing, by the BIM formation system, a first component file associated with the component model in response to receiving a selection of the import button; and
generating, by the BIM formation system, the component model using the first component file;
wherein the component model comprises at least one parametric equation.

17. The method of claim 16, further comprising:
providing, by the BIM formation system, a component file assembly user interface associated with the component model in response to receiving a selection of a component file assembly button provided on the configuration user interface;
providing, by the BIM formation system, a component file assembly tree associated with the component model, the component file assembly tree including:
a component file base assembly entry;
a first component file assembly entry; and
a second component file assembly entry; and
facilitating, by the BIM formation system, rearrangement of the first component file assembly entry and the second component file assembly entry within the component file assembly tree;
wherein one of the component file base assembly entry, the first component file assembly entry, or the second component file assembly entry corresponds to the first component file; and
wherein the others of the component file base assembly entry, the first component file assembly entry, or the second component file assembly entry correspond to a second component file and a third component file.

18. The method of claim 17, wherein the component file assembly tree dictates an order in which the first component file, the second component file, and the third component file are assembled to form the component model;
wherein the first component file is assembled to the second component file, and then the first component file and the second component file are assembled to the third component file when the second component file is located between the first component file and the third component file; and
wherein the first component file is assembled to the third component file, and then the first component file and the third component file are assembled to the second component file when the third component file is located between the first component file and the second component file.

19. The method of claim 17, further comprising providing, by the BIM formation system, a parent component name and a child component name on the component file assembly user interface in response to receiving a selection of the first component file assembly entry or the second component file assembly entry;
wherein the parent component name is associated with the component file base assembly entry; and
wherein the child component name is associated with the first component file assembly entry or the second component file assembly entry.

20. The method of claim 19, further comprising: providing, by the BIM formation system, a parent constraint name and a child constraint name on the component file assembly user interface in response to receiving a selection of the first component file assembly entry or the second component file assembly entry;
wherein the parent constraint name indicates a first constraint associated with the first component file, and between the first component file and the second component file or the third component file; and
wherein the child constraint name indicates a second constraint associated with the second component file or the third component file, and between the first component file and the second component file or the third component file.
